(19) United States
(12) Patent Application Publication
(10) Pub. No.: US 2025/0376132 A1
(43) Pub. Date: Dec. 11, 2025

(54) VEHICLE DEBRIS REMOVAL SYSTEM AND METHOD

(71) Applicant: Eichhorst Investments LLC, Otsego, MN (US)

(72) Inventors: Kyle Eichhorst, Otsego, MN (US); Kory Eichhorst, Otsego, MN (US)

(73) Assignee: Eichhorst Investments LLC, Otsego, MN (US)

(21) Appl. No.: 19/230,909

(22) Filed: Jun. 6, 2025

Related U.S. Application Data
(60) Provisional application No. 63/658,640, filed on Jun. 11, 2024.

(51) Int. Cl. B60S 3/04; B08B 1/10

(52) U.S. Cl. CPC B60S 3/042; B08B 1/10

(57) ABSTRACT

A debris removal system comprises a first debris removal assembly. The first debris removal assembly comprises a mat and one or more knobs for deforming the tire of a vehicle driving over the debris removal system. A second debris removal assembly is connectable to the first debris removal assembly using one or more connectors. The second debris removal assembly also comprises a mat and one or more knobs. The knobs are removable from the first debris removal assembly and the second debris removable assembly.

### BACKGROUND

Vehicle track out systems are measures used to minimize tracking of sediment, debris, and pollutants on vehicle wheels from construction sites onto public roads. These systems include combinations of devices and practices designed to capture or remove materials from vehicle tires before they leave the construction site. Common components of track out systems include rock beds, wheel wash systems, rumble grates, and stabilized construction site exits. These systems help prevent the contamination of public roads, stormwater systems, and nearby water bodies by reducing the spread of pollutants carried by vehicles leaving construction sites.

### SUMMARY

In general terms, this disclosure is directed to a debris removal assembly. In some embodiments, and by non-limiting example, the debris removal assembly functions to remove debris from the tires of a vehicle driving over the debris removal assembly. In some embodiments, the debris removal assembly comprises removable knobs that deform the tires of the vehicle. By removing the knobs, a user may customize the debris removal assembly to accommodate pedestrian walkways over which the debris removal assembly may be arranged. In some embodiments, the debris removal assembly also includes a curb protection panel to protect curbs over which the debris removal assembly may be arranged.

In certain examples a debris removal assembly for removing debris from a vehicle comprises a mat and one or more knobs attached to a top side of the mat. The one or more knobs are removable from the mat.

In certain examples a knob for deforming vehicle tire in a debris removal assembly comprises a top face, a bottom face, and a central hole extending from the top face through the bottom face.

In certain examples a debris removal system for removing debris from a vehicle comprises a first debris removal assembly, a second debris removal assembly, and a connector for connecting the first debris removal assembly to the second debris removal assembly.

In certain examples a method of assembling a debris removal system for a vehicle comprises arranging a first mat within an egress pathway of a construction site and attaching one or more knobs for deforming a tire of the vehicle to a top side of the first mat.

In certain examples a method of assembling a debris removal system for a vehicle comprises arranging a first mat within an egress pathway of a construction site; and removing one or more knobs for deforming a tire of the vehicle from a top side of the first mat.

In certain examples a mat for a debris removal assembly for a vehicle comprises a top face, a bottom face, an opening extending from the top face through the bottom face, and a T-nut extending through the opening.

### BRIEF DESCRIPTION OF THE DRAWINGS

FIG. 1 is perspective view of an example debris removal system.

FIG. 2 is a top view of the debris removal system of FIG. 1.

FIG. 3 is a top view of the debris removal system of FIG. 1 in an alternate configuration.

FIG. 4 is a top view of the debris removal system of FIG. 1 in another alternate configuration.

FIG. 5 is a perspective view of an example debris removal assembly of the debris removal system of FIG. 1.

FIG. 6 is top view of the debris removal assembly of FIG. 5.

FIG. 7 is a rear view of the debris removal assembly of FIG. 5.

FIG. 8 is a side view of the debris removal assembly of FIG. 5.

FIG. 9 is a bottom view of the debris removal assembly of FIG. 5.

FIG. 10 is a detail top perspective view of the debris removal assembly of FIG. 5.

FIG. 11 is a detail exploded view of the debris removal assembly of FIG. 5.

FIG. 12 is a top perspective view of an example knob of the debris removal assembly of FIG. 5.

FIG. 13 is a bottom perspective view of the knob of the FIG. 12

FIG. 14 is a side view of the knob of FIG. 12.

FIG. 15 is a top view of the knob of FIG. 12.

FIG. 16 is a bottom view of the knob of FIG. 12.

FIG. 17 is a perspective view of an example fastener of the debris removal assembly of FIG. 5.

FIG. 18 is a top perspective view of an example mat of the debris removal assembly of FIG. 5.

FIG. 19 is a detail cross-sectional view of the mat of FIG. 18.

FIG. 20 is a detail cross-sectional view of the debris removal assembly of FIG. 5.

FIG. 21 is a detail cross-sectional view of another debris removal assembly comprising of another example mat.

FIG. 22 is a detail top perspective view of the connector of the debris removal system of FIG. 1.

FIG. 23 is a detail cross-sectional view of the connector of FIG. 22.

FIG. 24 is a detail top view of the connectors of the debris removal system of FIG. 1.

FIG. 25 is a top view of an example curb protection panel.

FIG. 26 is a top perspective view of the curb protection panel of FIG. 25 connected to an example debris removal assembly.

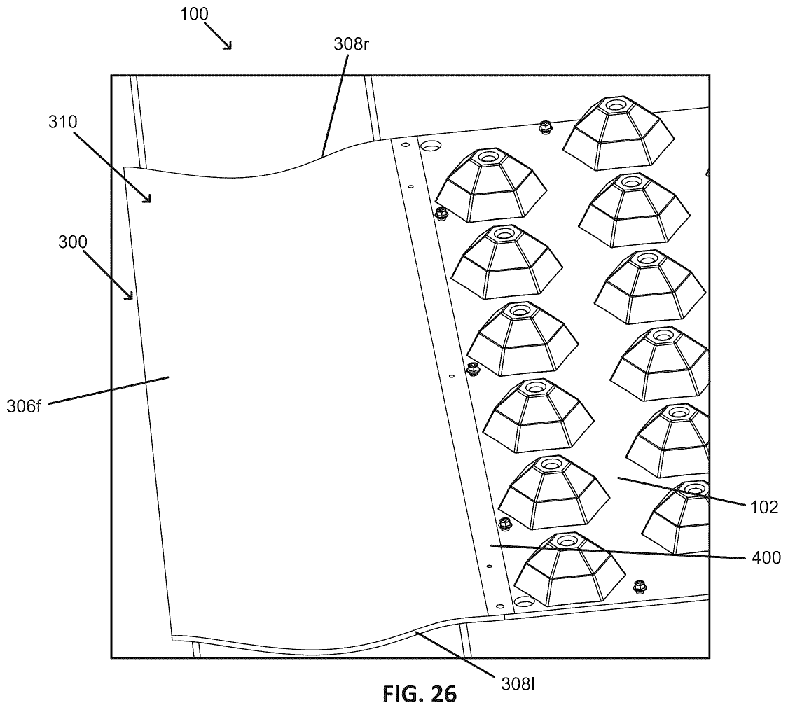

FIG. 27 is a top perspective view of an example debris removal system including the curb protection panel of FIG. 25 and an attachment.

FIG. 28 is a perspective view of an example walkway mat.

FIG. 29 is a perspective view of an example debris removal system including the example walkway mat of FIG. 28.

FIG. 30 is a top perspective view of another example mat.

FIG. 31 is a bottom perspective view of the mat of FIG. 30.

FIG. 32 is a detail bottom perspective view of the mat of FIG. 30.

FIG. 33 is a bottom perspective view of another example mat.

FIG. 34 is a detail bottom perspective view of the mat of FIG. 33.

FIG. 35 is a perspective view of an example attachment backing.

FIG. 36 is a bottom perspective view of another example mat.

FIG. 37 is a detail bottom perspective view of the mat of FIG. 36.

FIG. 38 is perspective view of another example attachment backing.

FIG. 39 is a perspective view of an example connector assembly.

FIG. 40 is another perspective view of the connector assembly of FIG. 39.

FIG. 41 is a cross-sectional view of the connector assembly of FIG. 39.

FIG. 42 is a bottom perspective view of the connector assembly of FIG. 39.

FIG. 43 is a top view of an example curb protection panel.

FIG. 44 is a perspective view of the example curb protection panel of FIG. 43 attached to a mat with a cover strip.

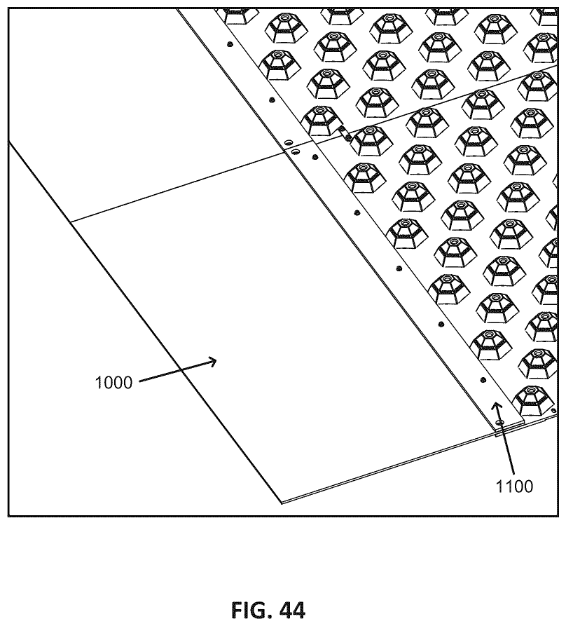

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

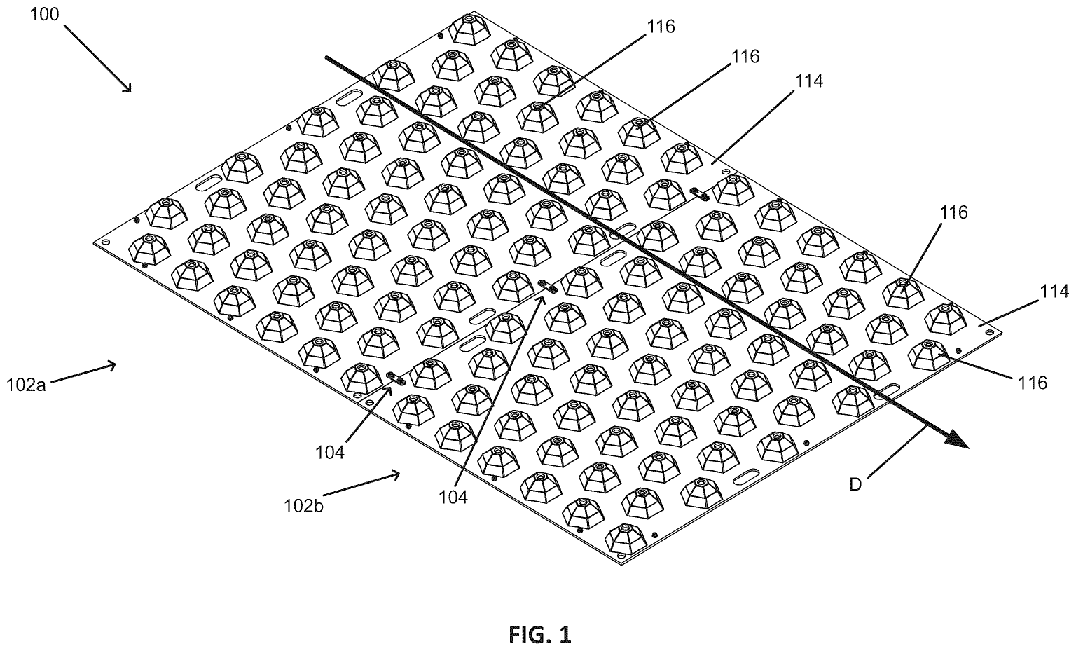

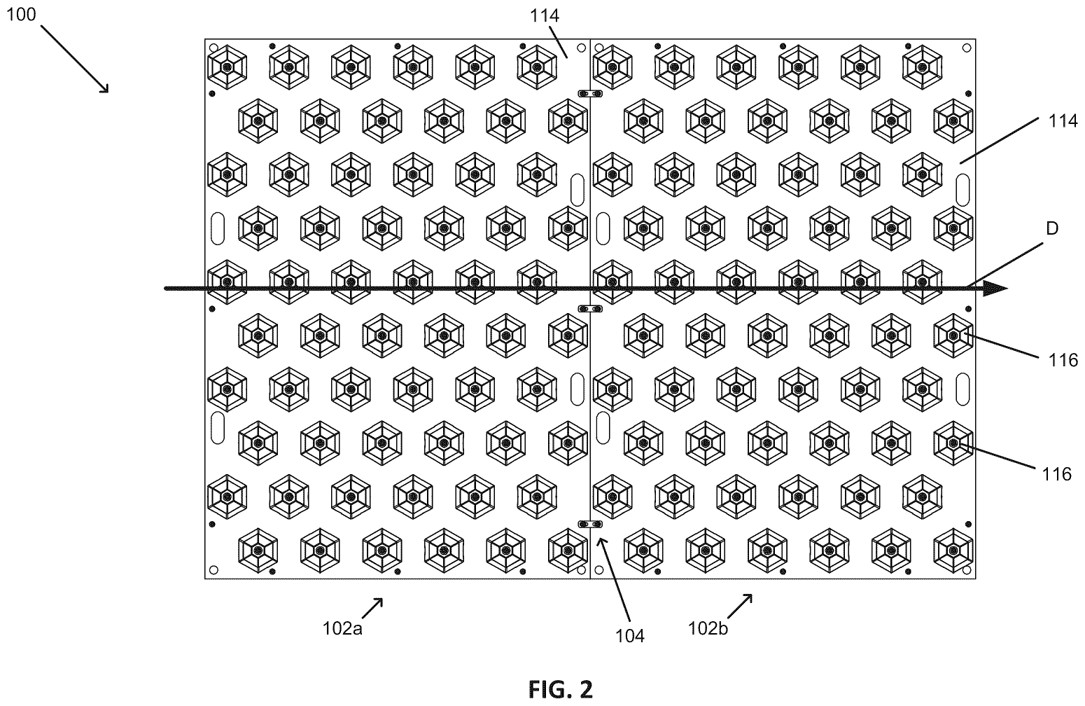

FIG. 1 is a perspective view of an example debris removal system 100. FIG. 2 is a top view of the example debris removal system 100. In some examples, the vehicle debris removal system includes one or more debris removal assemblies 102a, 102b. In some examples, the debris removal system 100 further includes one or more connectors 104 that connect the one or more debris removal assemblies 102a, 102b together to form the debris removal system 100. In some examples, the debris removal assemblies 102a, 102b include one or more knobs 116 arranged thereon.

In some examples, the knobs 116 of the debris removal assemblies 102a, 102b may be driven upon by a vehicle. In some examples, the knobs 116 deform one or more tires on the vehicle when the vehicle drives over the knobs 116. The deformation of the tires of the vehicle while driving over the debris removal system 100 may result in causing mud or other debris on the tire to fall from the tire. In some examples, the ability to connect debris removal assemblies 102a, 102b of the debris removal system 100 together allows a user to customize the length of the debris removal system 100 such that the vehicle can drive over a desired length of the debris removal system 100 in order to accomplish a desired amount of debris removal from the vehicle. While the debris removal system 100 is shown in the example of FIG. 1 and FIG. 2 as including two debris removal assemblies in some examples, greater or fewer debris removal assemblies 102a, 102b may be connected together and used within the debris removal system.

In some examples, when using the debris removal system 100, vehicles are able to travel over the debris removal system 100 along a direction of travel D. In some examples, when traveling over the debris removal system 100, the vehicle first travels over the first debris removal assembly 102a and later travels over the second debris removal assembly 102b. In other examples, the direction of travel is reversed such that the vehicle first travels over the second debris removal assembly 102b and later travels over the first debris removal assembly 102a.

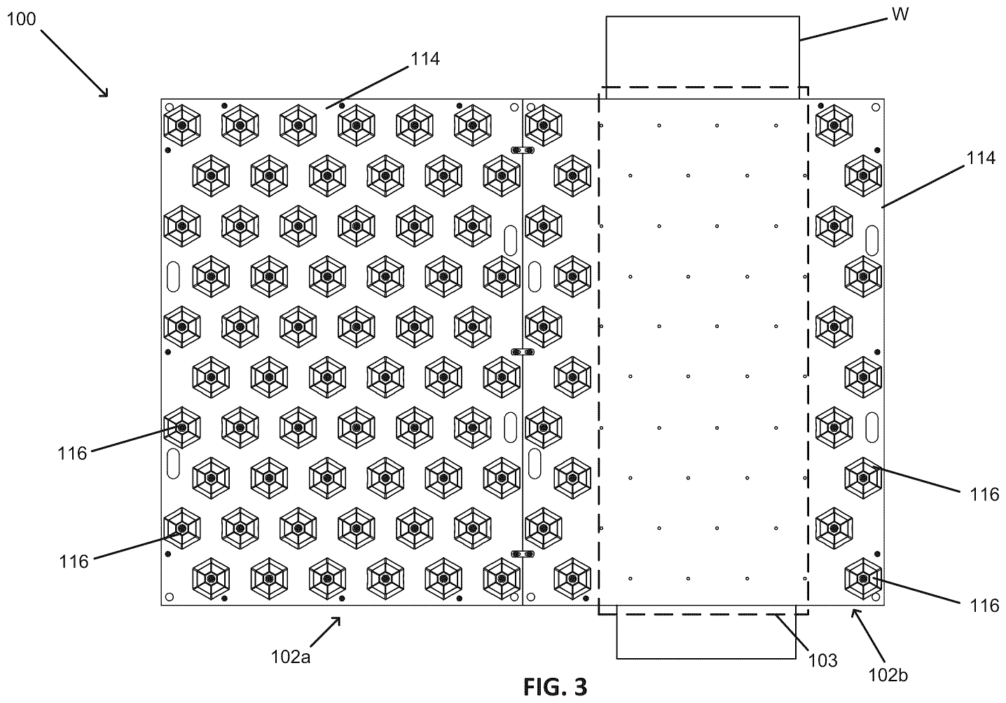

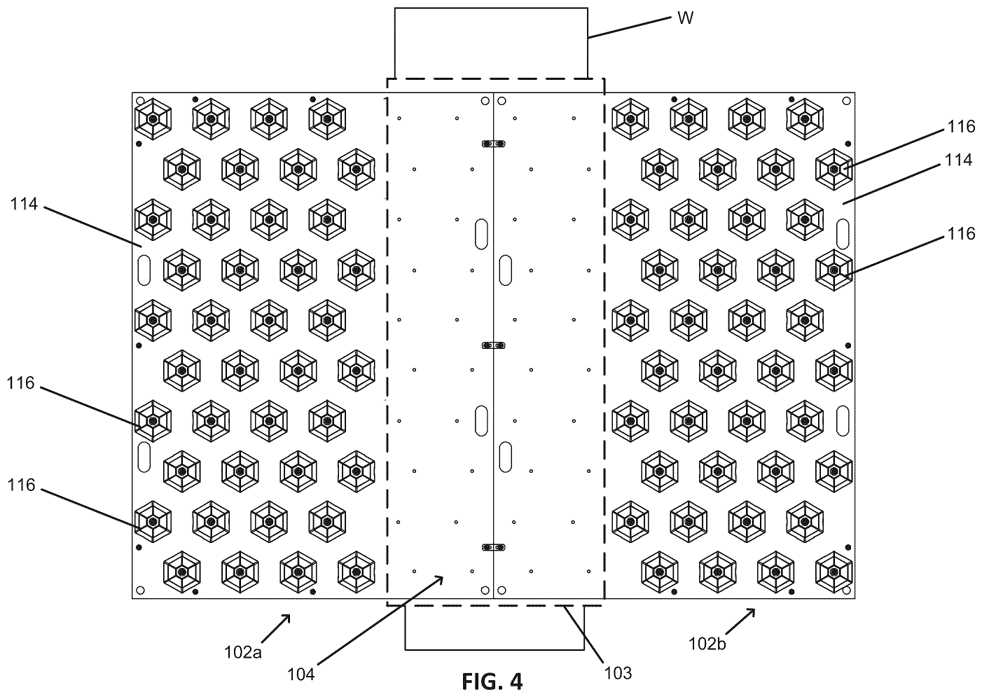

FIG. 3 is a top view of the debris removal system 100 in another arrangement. FIG. 4 is a top view of the debris removal system 100 in a further arrangement. In some examples, the debris removal system 100 is used in the entry or exit points of a construction site. In some examples, the entry and exit points are located adjacent walkways W such as residential sidewalks, and, in some examples, as shown in FIG. 3 and FIG. 3, may even cross such walkways W. In such examples, it may be desirable to modify the debris removal system 100 to accommodate the walkways W that the debris removal system 100 extends over. For example, in some examples, it may be desirable to configure the debris removal system 100 such that the debris removal system 100 does not include knobs 116 within the region of the debris removal system 100 that extends over the walkways W.

FIG. 3 is a top view of the debris removal system 100 in which the second debris removal assembly 102b extends over the walkway W. In the example of FIG. 3, the debris removal system 100 includes a knobless region 103 on the portion of the second debris removal assembly 102b that extends over the walkway W. In some examples, the size of the knobless region 103 is approximately the same width as the walkway W. In other examples, the size of the knobless region may vary such that the width of the knobless region 103 is slightly greater than the width of the walkway W. In some examples, the size of the knobless region may vary such that the width of the knobless region 103 is slightly less than the width of the walkway W.

FIG. 4 is a top view of the debris removal system 100 in which the first debris removal assembly 102a and the second debris removal assembly 102b each partially extend over the walkway W. In the example of FIG. 4, the debris removal system 100 includes a knobless region 103 on each of the portions of the first debris removal assembly 102a and the second debris removal assembly 102b that extends over the walkway W. In some examples, the size of the knobless region 103 may be configured in a similar manner to the size of the knobless region 103 describe with respect to FIG. 3.

In some examples, by providing the knobless region 103 on the debris removal system 100 over portions of the debris removal system 100 extending over a walkway W, the debris removal system 100 may be configured to permit pedestrians to easily cross the debris removal system 100 when traveling along the walkway. In some examples, the knobless region 103 further permits passage of pedestrians over the debris removal system 100 when the pedestrians are pushing scooters, disabled and traveling with the use of wheelchairs or walkers, or blind and traveling with the use of a cane.

In other examples, providing a knobless region 103 on the debris removal system 100 may be beneficial to permit crossing of the debris removal system (either within or outside of a construction site) by vehicles when the operator thereof does not wish to use the debris removal system to remove debris from the vehicle. In such examples, the vehicles may cross the debris removal system 100 in directions approximately perpendicular to the direction of travel D (shown in FIG. 1 and FIG. 2) within the knobless region 103.

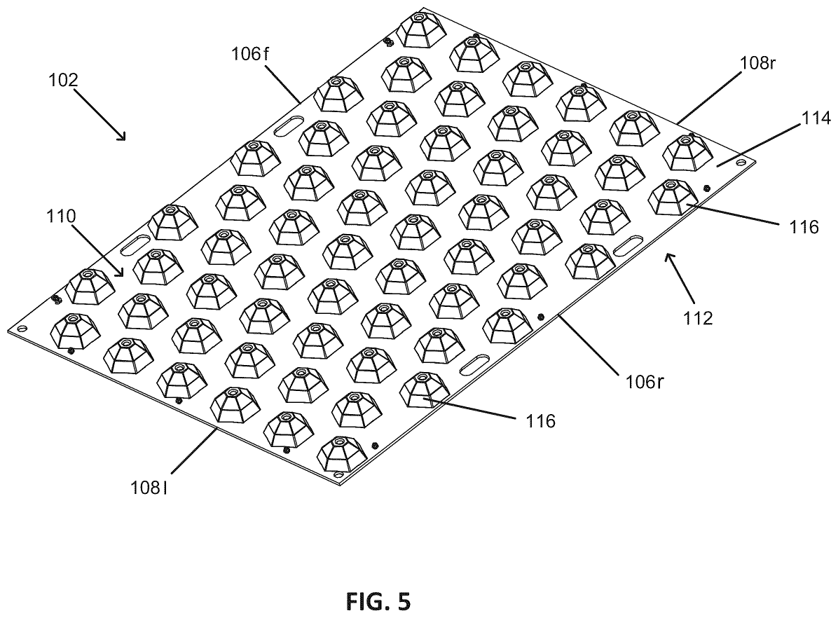

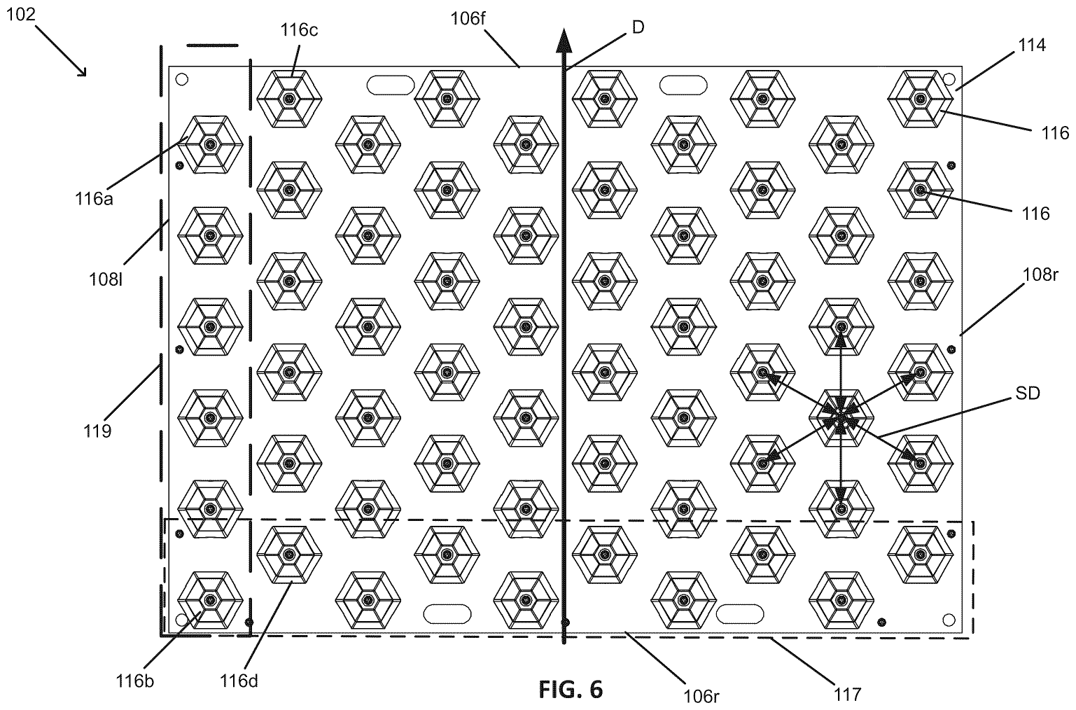

FIG. 5 is a perspective view of an example debris removal assembly 102 of the debris removal system 100 of FIG. 1 and FIG. 2. FIG. 6 is a top view of the debris removal system of FIG. 1 and FIG. 2. In some examples, the debris removal assembly 102 includes a first length edge 106f located on a front side of the debris removal assembly 102, a second length edge 106r located on a rear side of the debris removal assembly 102, a first width edge 1081 located on a left side of the debris removal assembly 102, and a second width edge 108r located on a right side of the debris removal assembly 102. In some examples, the debris removal assembly 102 further includes a top side 110 and a bottom side 112.

In some examples (as shown in FIG. 1 and FIG. 2), the example debris removal assemblies 102 are connectable along the length edges 106r, 106f to form the debris removal system 100. Specifically, in some examples, the first length edge 106f of the first debris removal assembly 102a is connectable to the second length edge 106r of the second debris removal assembly 102b. In some examples, additional debris removal assemblies 102 are connectable to the debris removal system 100 in this manner.

In some examples, the debris removal assembly 102 includes a mat 114 and one or more knobs 116. In some examples, each of the knobs 116 is shaped substantially identically. In some examples, the knobs 116 are arranged on the mat 114 along the top side 110 of the debris removal assembly 102.

As shown in FIG. 6, in some examples, the knobs 116 are arranged in rows such that one or more width rows 119 of knobs 116 extend from the first length edge 106f to the second length edge 106r. In some examples, the knobs 116 are arranged in rows such that one or more length rows 117 of knobs 116 extend from the first width edge 1081 to the second width edge 108r. In some examples, the one or more width rows 119 comprise a straight line of knobs 116 arranged linearly with respect to one another. In some examples, the one or more length rows 117 comprise a staggered zig-zagged pattern of knobs 116.

In some examples, one or more knobs 116 are arranged such that the knob 116 includes six surrounding knobs 116. In some examples, each one of the surrounding knobs 116 are equally spaced apart at an equal spacing distance SD from the knobs 116. In some examples, the spacing distance is about 9.65 inches, such as, for example, 9.65 inches.

In some examples, as discussed with respect to FIG. 3 and FIG. 4, the knobs 116 are removable from the mat 114. In some examples, the knobs 116 are re-attachable to the mat 114. In some examples, the knobs 116 are arranged on the mat 114 only on the top side 110 of the debris removal assembly 102. In some examples, the knobs 116 extend over substantially all of the top side 110 of the debris removal assembly 102.

In some examples, six knobs 116 extend between the first length edge 106f and the second length edge 106r of the mat 114 in each of the width rows 119. In some examples, 10 knobs 116 extend between the first width edge 1081 and the second width edge 108r in each of the length rows 117. In some examples, the direction of travel D extends along the debris removal assembly 102 between the first length edge 106f and the second length edge 106r along the width rows 119 and across the length rows 117.

In some examples, the starting point and ending point of each of the adjacent width rows 119 with respect to the first length edge 106f and the second length edge 106r is staggered. Specifically, in some examples, a first width row 119 adjacent to the first width edge 1081 comprises first knob 116a spaced a first distance from the first length edge 106f and a second knob 116b spaced a second distance from the second length edge 106r, with the first distance is greater than the second distance. Furthermore, a second width row 119 comprises a first knob 116c spaced the second distance from the first length edge 106f and a second knob 116d spaced the first distance from the second length edge 106r.

Referring back to FIG. 2, in some examples, when the first debris removal assembly 102a is placed next to the second debris removal assembly 102b, the knobs 116 are arranged such that one or more width rows 119 extends along the debris removal system 100 from the first debris removal assembly 102a to the second debris removal 102b in a substantially uninterrupted manner. In some examples, the when the first debris removal assembly 102a is placed next to the second debris removal assembly 102b, the knobs 116 are arranged such that there is a space between the width row 119 of the first debris removal assembly 102a and the width row 119 of the second debris removal assembly 102b in some examples, the space is less than the space between adjacent knobs 116 within the width row 119 of the first debris removal assembly 102a or the second debris removal assembly 102b.

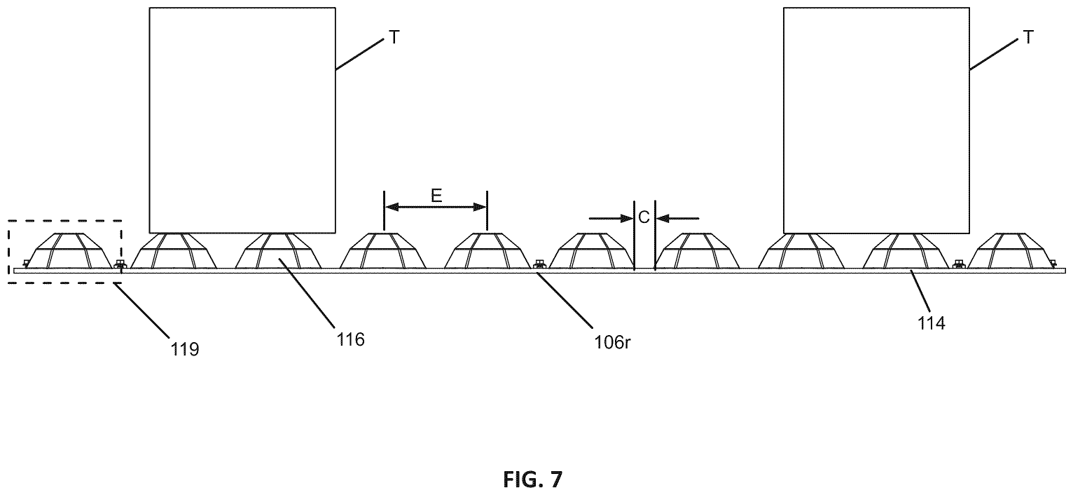

FIG. 7 is a rear view of the example debris removal assembly 102 when viewed from the second length edge 106r. In some examples, as shown in FIG. 7, each of the width rows 119 extend linearly from the second length edge 106r. In some examples, each edge of the width rows 119 is spaced from each edge of the adjacent width row 119 to form a channel C. In some examples, the channel C is approximately 1.5 inches, such as, for example, 1.5 inches. In some examples, each of the width rows 119 are spaced from each other such that the center points of each on of the knobs 116 in the respective width rows 119 are spaced apart from each other by a distance E. In some examples, the distance E is between approximately 8 inches to approximately 9 inches, such as, for example, 8.357 inches.

As shown in FIG. 7, the debris removal assembly 102 is configured such that when traveling along the direction of travel D (shown in FIG. 6), tires T of a vehicle span across one or more of the width rows 119 of the debris removal assembly 102. In some examples, the debris removal assembly 102 is configured such that when traveling along the direction of travel D (shown in FIG. 6), tires T of a vehicle span across two or more of the width rows 119 of the debris removal assembly 102.

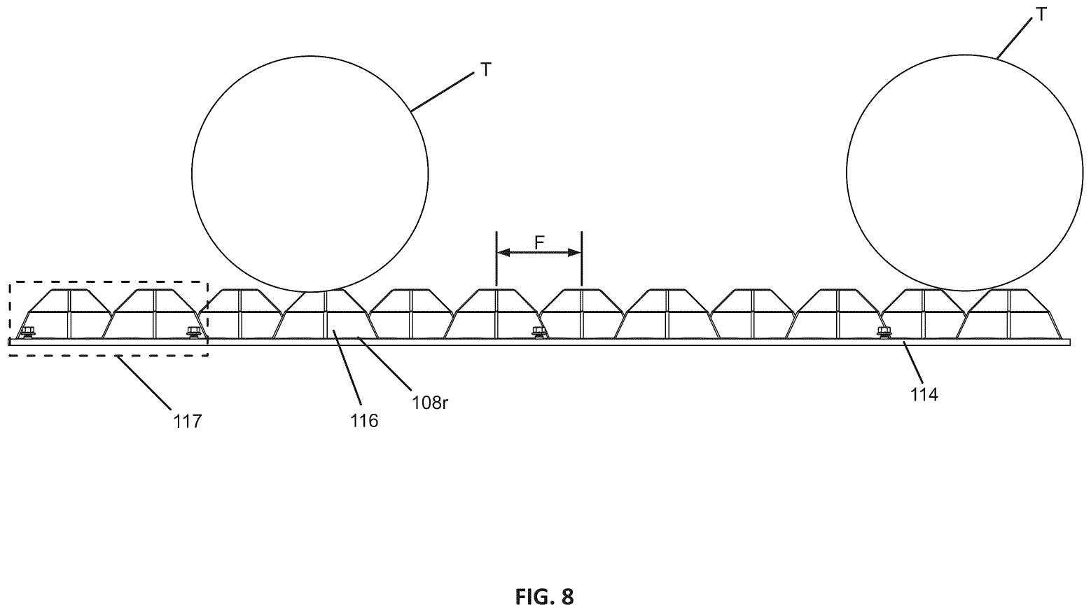

FIG. 8 is a side view of the example debris removal assembly 102 when viewed from the second width edge 108r. In some examples, when viewed from the second width edge 108r, the staggering of the length rows 117 is shown. In some examples, each edge of the width rows 119 is spaced from each edge of the adjacent width row 119 such that no channel is formed therebetween. In some examples, each of the knobs 116 within each of the width rows 119 are staggered from each other by a distance F. In some examples, the distance F is between approximately 4 inches to approximately 5.5 inches, such as, for example, 4.825 inches. In some examples, as shown in FIG. 8, when traveling in the direction of travel D (shown in FIG. 6), tires T of a vehicle travel over and across each of the length rows 117 of the debris removal assembly 102.

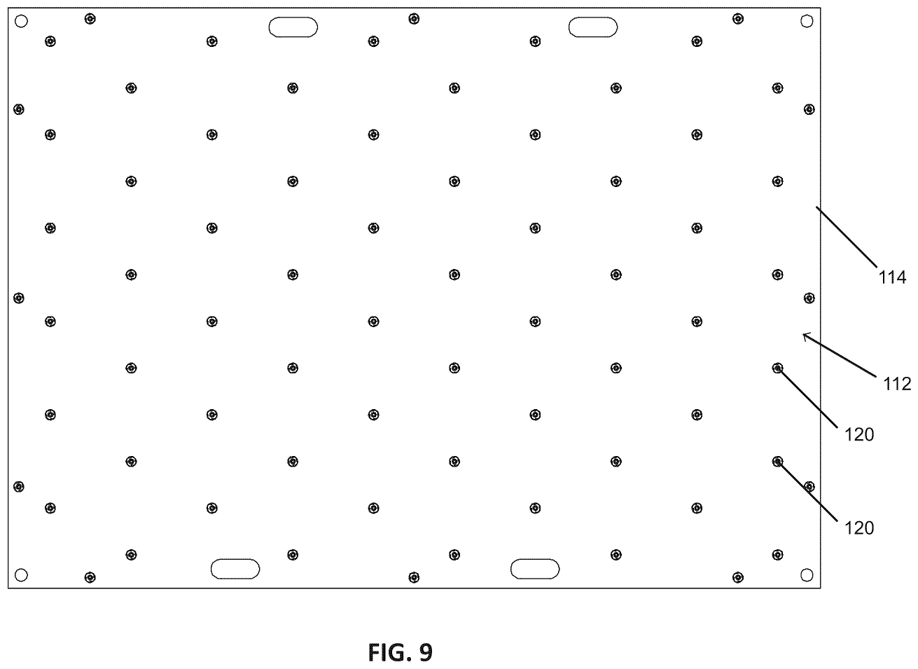

FIG. 9 is a bottom view of the example debris removal assembly 102. In some examples, the debris removal assembly 102 includes one or more nuts 120 arranged on the bottom side of the debris removal assembly 102. In some examples, the nuts 120 are arranged along the bottom side 112 of the of the debris removal assembly 102 in a similar manner to the manner in which the knobs 116 are arranged along the top side 110 of the of the debris removal assembly 102.

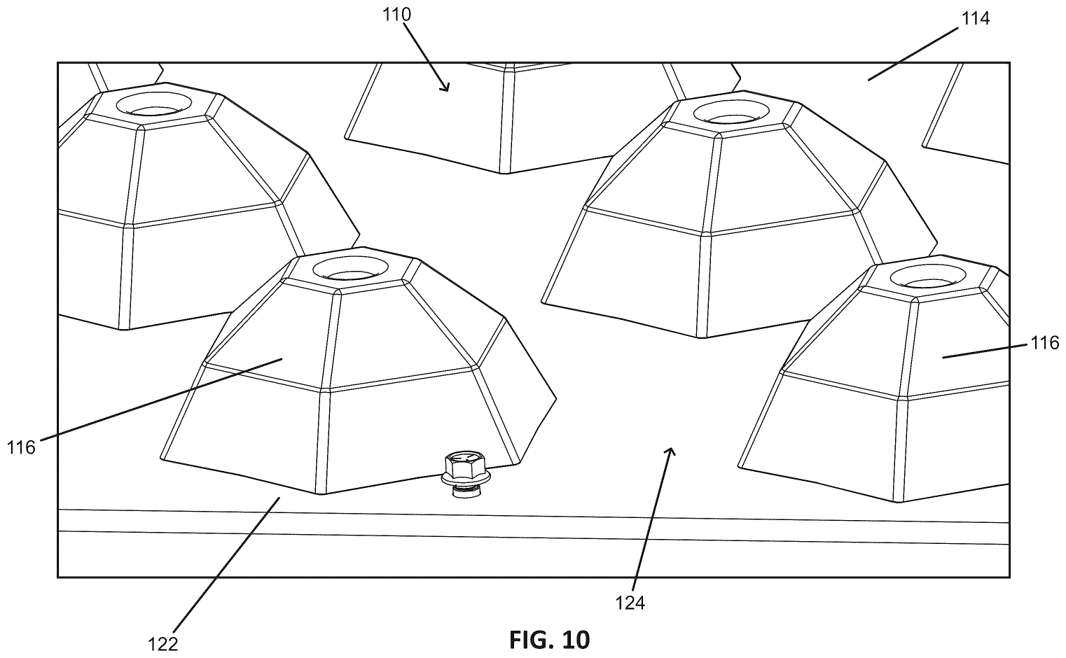

FIG. 10 is a perspective view of the example knobs 116 secured to the mat 114 on the top side 110 of the debris removal assembly. As shown in FIG. 10, in some examples, the knob 116 is arranged on the mat 114 such that a bottom side 122 of the knob 116 is flush with the top side 110 of the mat 114. In some examples, the debris removal assembly 102 further includes spaces 124 between the knobs 116. In some examples, the spaces 124 have approximately the same width as a width of the knobs 116. In other examples, the spaces 124 are approximately less than the width of the knobs 116.

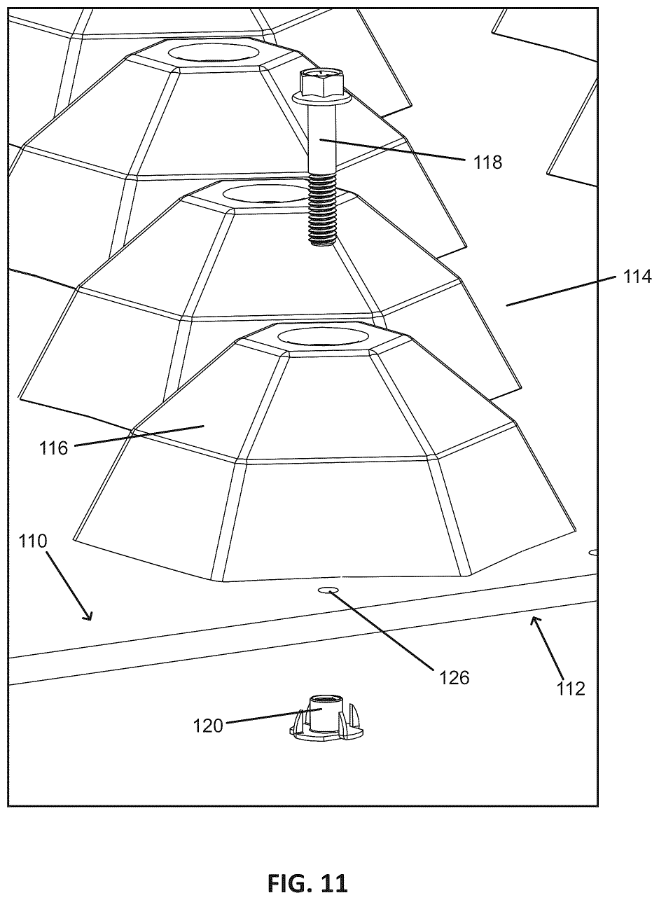

FIG. 11 is an exploded view of the example knob 116, the mat 114, and a fastener. In some examples, the fastener includes a bolt 118. In some examples, the fastener further includes a nut 120.

In some examples, the fastener secures the knob 116 to the mat 114. Specifically, the bolt 118 extends through the knob 116 to secure the knob 116 to the mat 114. In some examples, the bolt 118 is a hex bolt. In some examples, the bolt 118 further extends through the mat 114, such as, for example, through an attachment opening 126 of the mat 114. In some examples, the bolt 118 threads directly into the mat 114. In other examples, such as in the example of FIG. 11, the bolt extends through the mat 114 and threads into the nut 120. In some examples, the nut 120 is arranged adjacent a bottom side 112 of the debris removal assembly 102. In some examples, the nut 120 is a T-nut, such as, for example, a pronged T-nut.

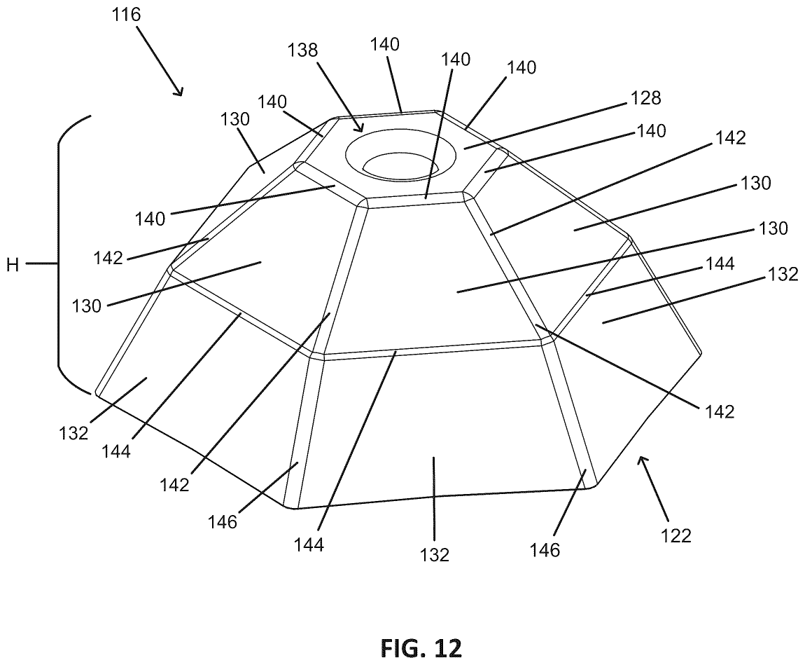

FIG. 12 is a perspective view of an example knob 116. In some examples, the knob 116 incudes a bottom side 122, and a height H. In some examples, the height H of the examples knob 116 extends from the bottom side 122 of the knob 116 to an upper end of the knob 116. In some examples, the height H of the knob 116 is approximately 2.75 inches, such as, for example, 2.75 inches.

In some examples, the knob 116 further includes a top face 128. In some examples, the knob 116 further includes one or more angled faces 130, 132. In some examples, the one or more angled faces 130, 132 extend between the bottom side 122 and the top face 128 of the knob 116. In some examples, the one or more angled faces 130, 132 comprise one or more upper angled faces 130 and one or more lower angled faces 132. In some examples, the one or more lower angled faces 132 connect to the bottom side 122 of the knob 116 at a lower end thereof and connect to one or more of the upper angled faces 130 at an upper end thereof. In some examples the one or more upper angled faces 130 connect to the one or more of the lower angled faces 132 at a lower end thereof and connect to the top face 128 at an upper end thereof.

In some examples, the top face 128 is arranged substantially parallel to the top side of the mat 114 when arranged thereon. In some examples, the top face 128 is substantially parallel to the bottom side 122 of the knob. In some examples, the lower angled faces 132 are arranged at a greater angle with respect to the top face 128 than the angle of the upper angled faces 130 with respect to the top face 128.

In some examples, the top face 128 is formed as a polygon. In some examples, the number of angled faces 130, 132 is equal to the number of sides of the polygon shape of the top face 128. In other examples, the number of angled faces 130, 132 is double the number of sides of the polygon shape of the top face 128. In some examples, the number of upper angled faces 130 is equal to the number of sides of the polygon shape of the top face 128, and the number of lower angled faces 132 is equal to the number of sides of the polygon shape of the top face 128. In some examples, the top face 128 is a hexagon and the number of upper angled faces 130 is six and the number of lower angled faces 132 is six. In some examples, in addition to the upper angled faces 130 and the lower angled faces 132, the knob 116 includes one or more intermediate angled faces.

In some examples, each of the angled faces 130, 132 is formed in an isosceles trapezoidal shape. In some examples, each one of the top sides of the isosceles trapezoidal shaped upper angled faces 130 contacts each one of the sides of the polygon shaped top face 128. In some examples, each one of the top sides of the isosceles trapezoidal shaped lower angled faces 132 contacts one of the bottom sides of each of the trapezoidal shaped upper angled faces 130.

In some examples, the knob 116 further includes a central hole 138. In some examples, the central hole 138 extends through the top face 128. In some examples, the central hole 138 extends through the entire knob 116 from the top face 128 out through the bottom side 122 of the knob 116.

In some examples, the knob 116 further includes top-upper angled face edges 140, upper-upper angled face edges 142, upper-lower angled face edges 144, and lower-lower angled face edges 146. In some examples, the knob 116 includes six top-upper angled face edges 140, six upper-upper angled face edges 142, six upper-lower angled face edges 144, and six lower-lower angled face edges 146. In some examples, each of the top-upper angled face edges 140 extend between each side of the top face 128 and each one of the top sides of the isosceles trapezoidal shaped upper angled faces 130. In some examples, the upper-upper angled face edges 142 extend between each one of the upper angled faces 130 and the laterally adjacent upper angled faces 130. In some examples, the upper-lower angled face edges 144 extend between each one of the bottom sides of the upper angled faces 130 and the top sides of the lower angled faces 132. In some examples, the lower-lower angled face edges 146 extend between each one of the lower angled faces 132 and the laterally adjacent lower angled faces 132.

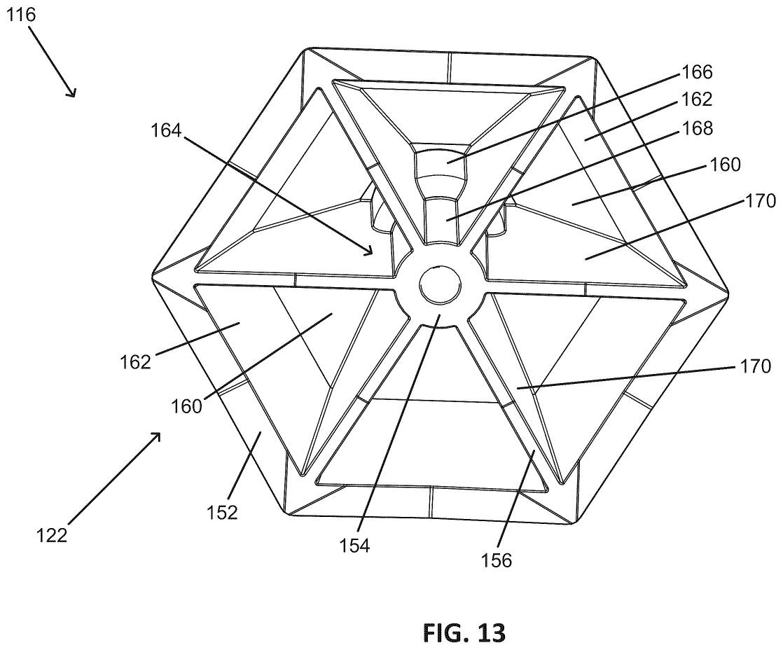

FIG. 13 is a bottom perspective view of the knob 116. In some examples, the knob 116 includes a bottom side 122. In some examples, the bottom side 122 comprises a bottom perimeter surface 152, a bottom middle circular surface 154, and bottom rib surfaces 156. In some examples, the bottom middle circular surface 154 is arranged within the bottom perimeter surface 152 substantially in the middle of the bottom perimeter surface 152. In some examples, the bottom rib surfaces 156 extend between the bottom perimeter surface 152 and the bottom middle circular surface 154. In some examples, an outer perimeter of the bottom perimeter surface 152 is comprises the same shape as the shape of the top face 128 of the knob 116.

In some examples, the knob 116 further includes upper bottom angled faces 160 and lower bottom angled faces 162 formed on the bottom sides of the upper angled faces 130 and lower angled faces 132 respectively. In some examples, each of the upper bottom angled face 160 and lower bottom angled face 162 are accessible from the bottom side 122 of the knob 116. In some examples, the knob 116 further includes a core 164 that extends in the center of the knob 116 from the bottom middle circular surface 154 up to upper edges of the upper bottom angled faces 160. In some examples, the core 164 varies in length along its height such that the core 164 includes an upper greater diameter portion 166 and a lower smaller diameter portion 168.

In some examples, the knob 116 further comprises one or more ribs 170. In some examples, the ribs 170 are arranged between the adjacent lower bottom angled faces 162. In some examples, the ribs 170 are further arranged between the adjacent upper bottom angled faces 160. In some examples, the ribs 170 extend from between the adjacent lower bottom angled faces 162 and the adjacent upper bottom angled faces 160 to the core 164. In some examples, the ribs 170 and the core 164 provide structural strength to the knob 116 as force is applied to the knob 116 through any one or more of the top face 128, the upper angled face 130, and the lower angled face 132.

In some examples, the knob 116 comprises a solid material, such as, for example, plastic. In some examples, the knob 116 comprises an HDPE plastic material. In some examples, the knobs 116 may be formed by injection molding. In other examples, the knobs 116 are formed by machining. In some examples, the knobs 116 may be formed by thermoforming.

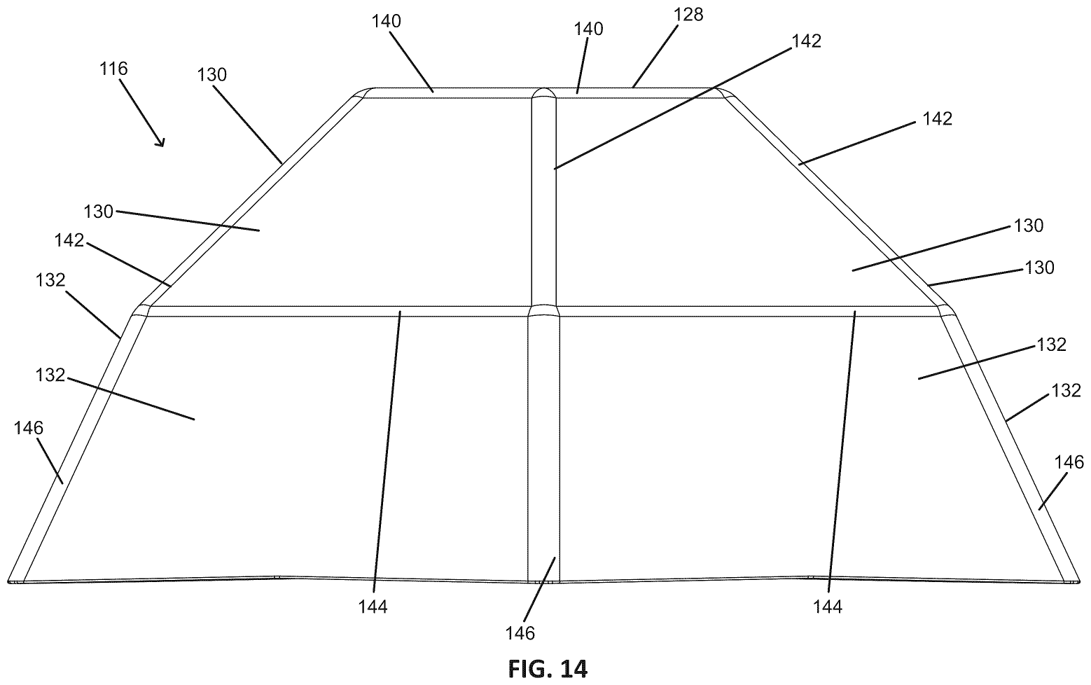

FIG. 14 is a side view of the example knob 116. As shown in FIG. 14, in some examples, the knob 116 further comprises a width W measured from a bottom point on the lower-lower angled face edges 146 on opposite sides of the knob 116. In some examples, the width W is about 6.88 inches, such as, for example, 6.88 inches.

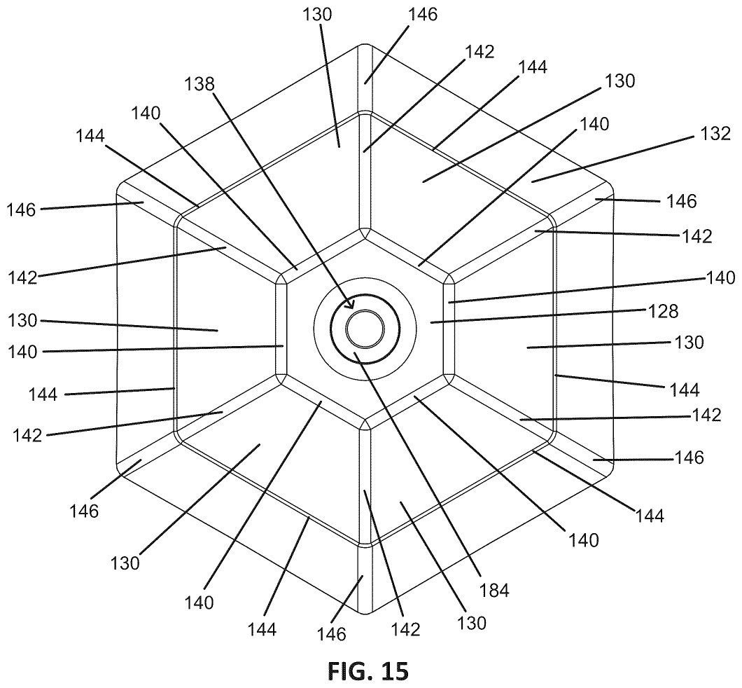

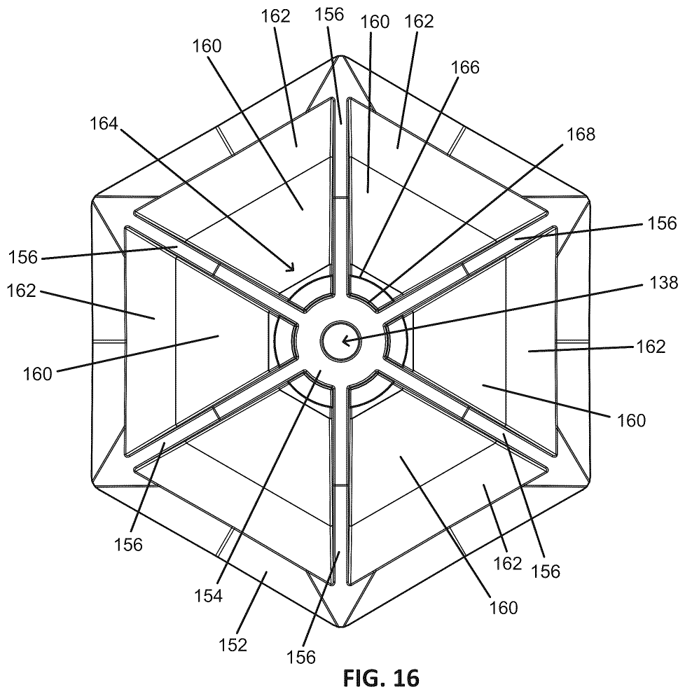

FIG. 15 is a top view of the example knob. FIG. 16 is a bottom view of the example knob. In some examples, as shown in the example of FIG. 15 and FIG. 16, the central hole 138 of the knob 116 varies in diameter along the length of the central hole 138. In some examples, the central hole 138 comprises a first diameter portion within the upper greater diameter portion 166. In some examples, the central hole 138 comprises a second diameter portion within the lower smaller diameter portion 168. In some examples, the knob 116 comprises a shoulder 184 separating the first diameter portion from the second diameter portion of the central hole 138.

In some examples, the construction of the knob 116 permits the knob to withstand significant forces on one or more of the top face 128, or angled faces 130, 132 exerted by vehicles driving over the knob 116 while maintaining its structural integrity. In some examples, the construction of the knob 116 permits the knob to withstand forces applied by vehicle having a weight of approximately 10 tons per axle.

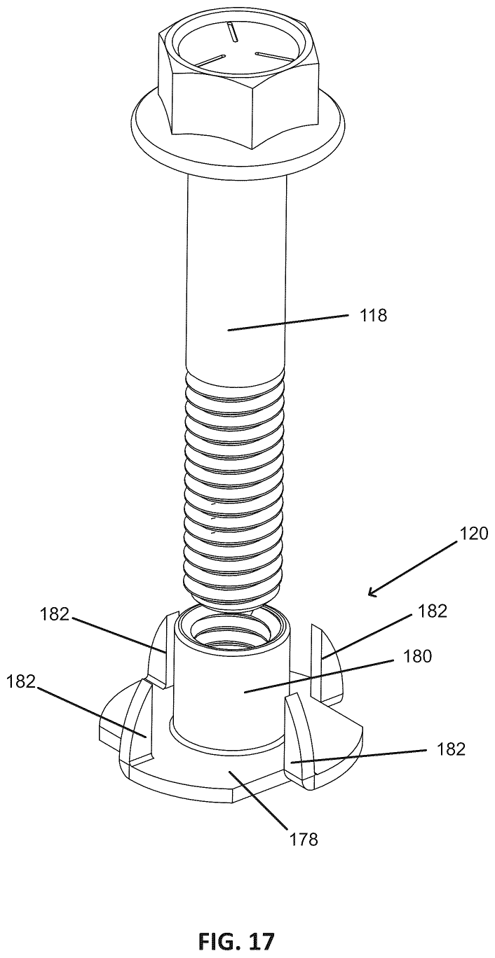

FIG. 17 is a perspective view of an example fastener. In the example of FIG. 17, the fastener comprises a bolt 118 and a nut 120. In some examples, the bolt 118 is less than about 2.75 inches long, such as, for example, 2.5 inches long or 2 inches long. In some examples, the bolt 118 is approximately 0.5 inches in diameter. In some examples, the nut 120 comprises a pronged T-nut. In some examples, the nut 120 is sized to receive the threads of the bolt 118 and threadedly engage with the bolt 118.

In some examples, the nut 120 comprises a flange 178, a neck 180, and one or more prongs 182. In some examples, each of the prongs 182 and the neck 180 extend upwardly from the flange 178. In some examples, the neck 180 comprises internal threads for engaging with the bolt 118.

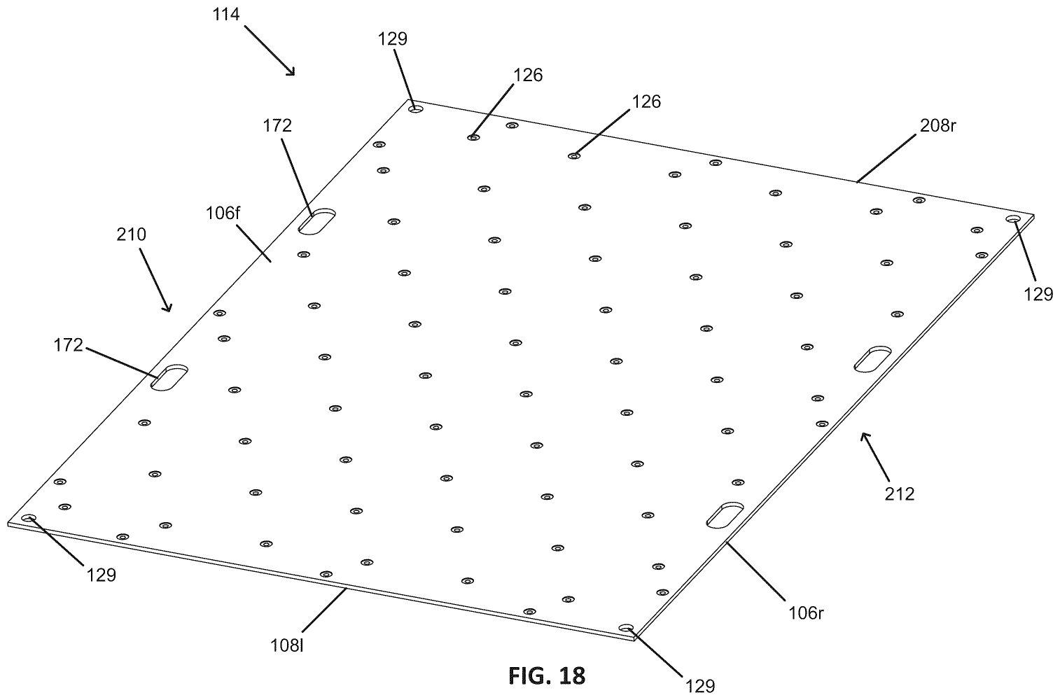

FIG. 18 is a perspective view of the example mat 114. In some examples, the mat 114 includes a first length edge 106f located on a front side of the mat 114, a second length edge 106r located on a rear side of the mat 114, a first width edge 1081 located on a left side of the mat 114, and a second width edge 108r located on a right side of the mat 114. In some examples, the mat 114 further includes a top side 210 and a bottom side 212.

In some examples, the mat 114 further includes one or more attachment openings 126, one or more handle openings 172, one or more connection openings 127, and one or more corner openings 129.

In some examples, the attachment openings 126 extend through the mat 114 from the top side 210 through the bottom side 212. In some examples, the attachment openings 126 are spread substantially across the entire top side 210 of the mat 114. In some examples, the attachment openings 126 are approximately 0.465 inches in diameter, such as, for example, 0.465 inches in diameter. In some examples, the attachment openings 126 are arranged across the mat 114 in a substantially similar manner to the manner in which the knobs 116 are arranged across the mat 114, as described with respect to FIG. 6.

In some examples, the handle openings 172 extend through the mat 114 from the top side 210 through the bottom side 212. In some examples, the handle openings 172 are each arranged on the mat 114 along the first length edge 106f and the second length edge 106r. In some examples, the mat 114 comprises four handle openings 172, with two handle openings 172 arranged along the first length edge 106f and two handle openings 172 arranged along the second length edge 106r. In some examples, the handle openings 172 provide locations for one or more users to insert hands and pick up or drag the mat 114 between locations.

In some examples, the mat 114 further includes one or more connection openings 127. In some examples, the connection openings 127 are similar in many aspects to the attachment openings 126. In some examples, the connection openings 127 are arranged on the mat 114 along the perimeter of the mat 114. Thus, in some examples, the mat 114 includes one or more connection openings 127 along one or more of the first length edge 106f, second length edge 106r, first width edge 1081, and second width edge 108r. In some examples, the mat 114 includes three connection openings 127 along each of the first length edge 106f, second length edge 106r, first width edge 1081, and second width edge 108r.

In some examples, the mat 114 further comprises one or more corner openings 129. In some examples, the one or more corner openings 129 extend through the top side 210 and the bottom side 212 of the mat 114. In some examples, the corner openings 129 are larger in diameter than the attachment openings 126 or the connection openings 127. In some examples, the corner openings 129 are about 1.25 inches in diameter, such as, for example, 1.25 inches. In some examples, the one or more corner openings 129 provide locations for a user to drive stakes through into the ground so as to fix the mat 114 in a particular location. In some examples, the one or more corner openings 129 provide locations for a user to insert a manhole cover hook and drag the mat 114 using the manhole cover hook.

The mat 114 may be made from a variety of materials. In some examples, the mat 114 comprises a metal material. In other examples, the mat 114 comprises a plastic material. In some examples, the mat 114 comprises a polyethylene material, such as, for example, a high density polyethylene material. In some examples, the mat 114 is rectangular shaped. In some examples, the mat 114 is about 0.375 inches thick, such as, for example, 0.375 inches thick. In some examples, the mat 114 is about 0.5 inches thick, such as, for example, 0.5 inches thick. In some examples, the first and second length edges 106r, 106f are longer than the first and second width edges 1081, 108r. In some examples, the first and second length edges 106r, 106f are about 7 feet long, such as, for example, 7 feet long. In some examples, the first and second width edges 1081, 108r are about 5 feet long, such as, for example, 5 feet long.

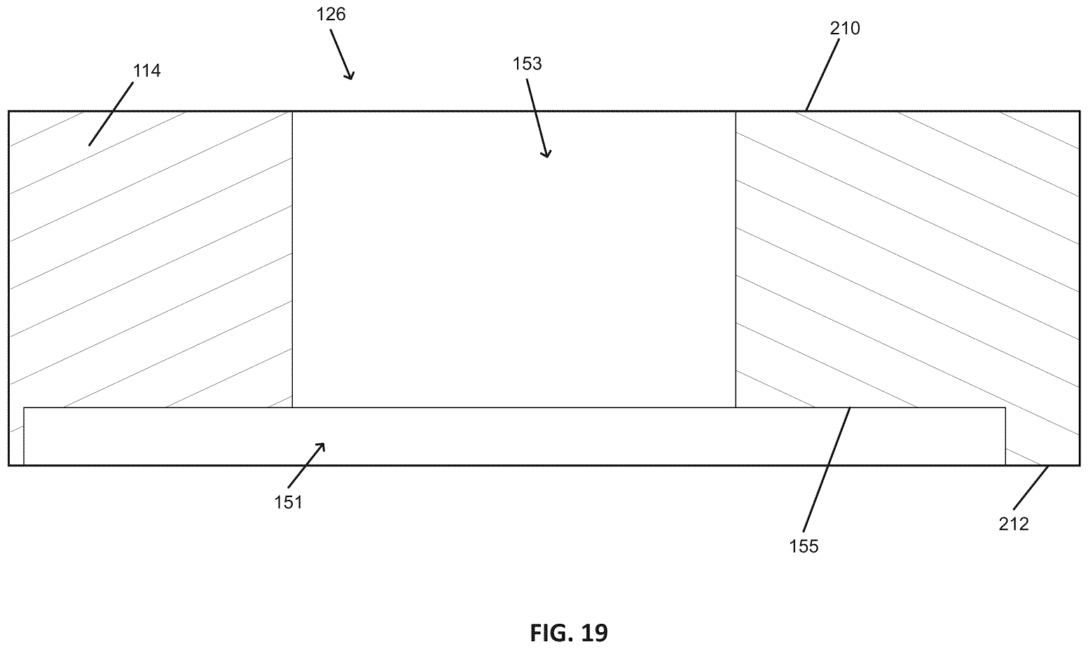

FIG. 19 is a cross-sectional view of the attachment opening 126. In some examples, the attachment opening 126 is similar in many aspects to the connection opening 127. In some examples, the attachment opening 126 includes a first diameter portion 153 that extends through the top side 210 of the mat 114. In some examples, the attachment opening 126 further includes a second diameter portion 151 that extends through the bottom side 212 of the mat 114. In some examples, the second diameter portion 151 is greater than the first diameter portion 153. In some examples, a portion of the second diameter portion 151 terminates in a shoulder 155, at which point the attachment opening 126 continues through the top side 210 of the mat 114 via the first diameter portion 153.

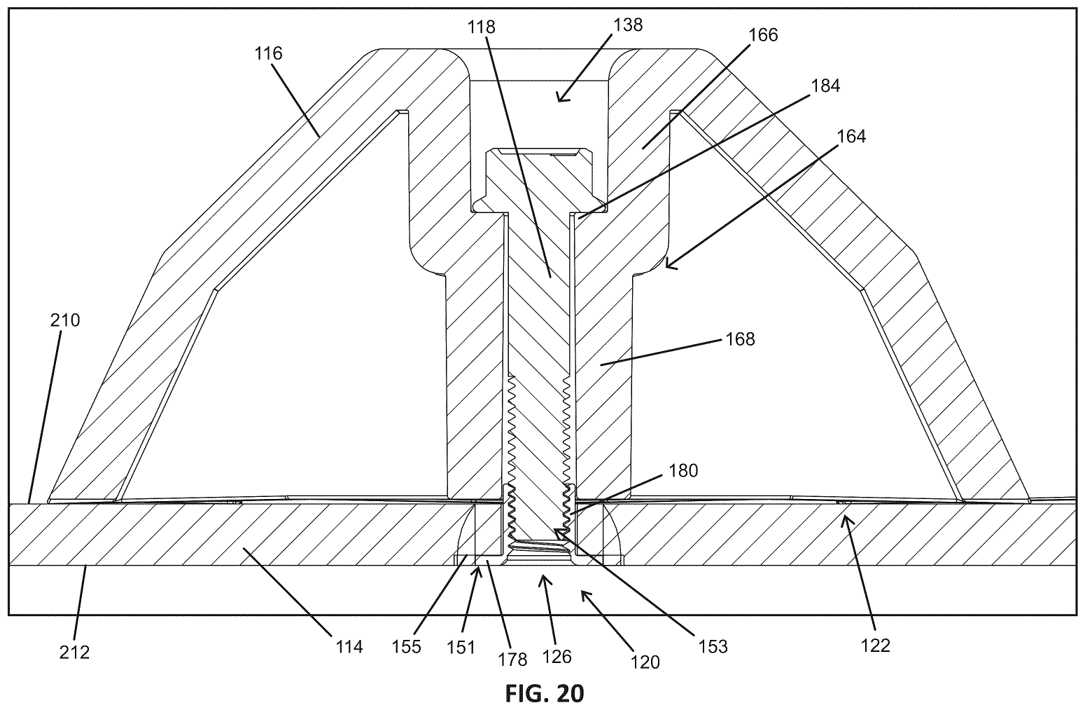

FIG. 20 is a cross-sectional view of the knob 116 secured to the mat 114. As shown in the example of FIG. 20, in some examples, the bottom side 122 of the knob 116 is mated with the top side 210 of the mat 114. In some examples, the central hole 138 of the knob 116 is aligned with an attachment opening 126. In some examples, a nut 120 is inserted into the attachment opening 126. Specifically, the nut 120 is arranged such that the flange 178 of the nut 120 fits within the second diameter portion 151 and contacts the shoulder 155. In some examples, the neck 180 of the nut 120 extends through the first diameter portion 153. In some examples, the neck 180 of the nut 120 extends out through the top side 210 of the mat 114. In some examples, a portion of the neck 180 extends into the central hole 138 of the knob 116. In some examples, the prongs 182 of the nut 120 extend into the shoulder 155 as the bolt 118 is tightened into the nut 120. In some examples, this causes the nut 120 to be rotatably fixed with respect to the mat 114 while the bolt 118 is rotated into the nut 120.

In some examples, the bolt 118 extends through the knob 116 such that a threaded portion of the bolt 118 extends through the second diameter portion of the central hole 138 within the lower smaller diameter portion 168 of the core 164. In some examples, the threaded portion of the bolt 118 extends into the threaded portion of the neck 180 of the nut 120 and threadedly engages with the nut 120. In some examples, a head of the bolt 118 is arranged within the first diameter portion of the central hole 138 within the upper greater diameter portion 166 of the core 164. In some examples, as the bolt 118 is threadedly engaged with the nut 120, the head of the bolt 118 contacts the shoulder 184 of the central hole 138. In some examples, the bolt 118 may continue to be threaded into the nut 120, which causes the bolt 118 to compress the knob 116 against the mat 114. In some examples, the length of the bolt 118 is selected such that when fully engaged with the nut 120 through the

Similarly, in some examples, the knob 116 may be removed from the mat 114 by unthreading the bolt 118 from the nut 120 such that the bolt 118 is no longer threadedly engaged with the nut 120 and lifting the knob 116 from the top surface 220 of the mat 114.

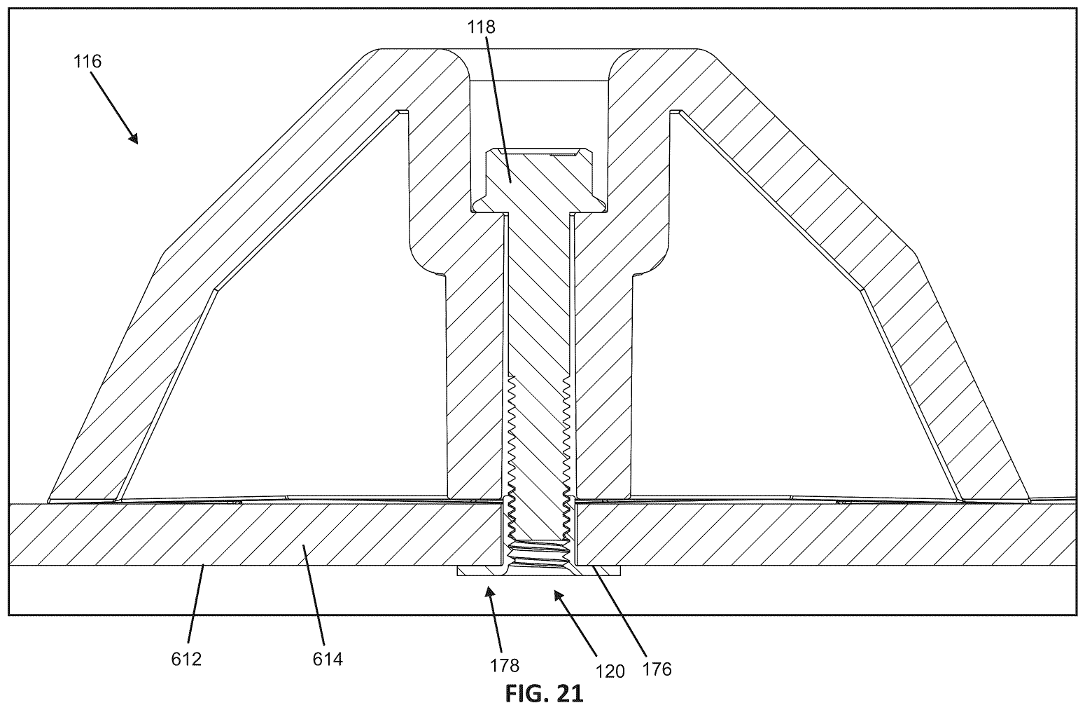

FIG. 21 is a cross-sectional view of the knob 116 secured to another example mat 614 for use within a debris removal system 100. In some examples, the securement of the knob 116 to the mat 614 is substantially same as the securement of the knob 116 to the mat 114, as described with reference to FIG. 20. In some examples, the mat 114 differs from the mat 114 in that the mat 614 does not include a second diameter portion 151 or a shoulder 155. Thus, in some examples, the mat 614 includes a plurality of openings that extend completely through the mat 614 with no significant change in diameter between the top side and the bottom side 612 of the mat 614. In some examples, when connected to the mat 614, the top side of the flange 176 of the nut 120 contacts the bottom side 612 of the mat 614. In some examples, because the mat 614 does not include a second diameter portion 151, the flange 176 of the nut 120 extends below the bottom surface of the mat 614. In some examples, the configuration of FIG. 21 is beneficial, as it is easier to manufacture given that only a single diameter hole need be formed in the mat 614. In some examples, the configuration of FIG. 20 is beneficial, as it avoids causing pressure points in the surface upon which the mat 114 is placed that are caused by the bottom surfaces of the flange 178 being pushed into the surface when a vehicle is driven over the debris removal system 100.

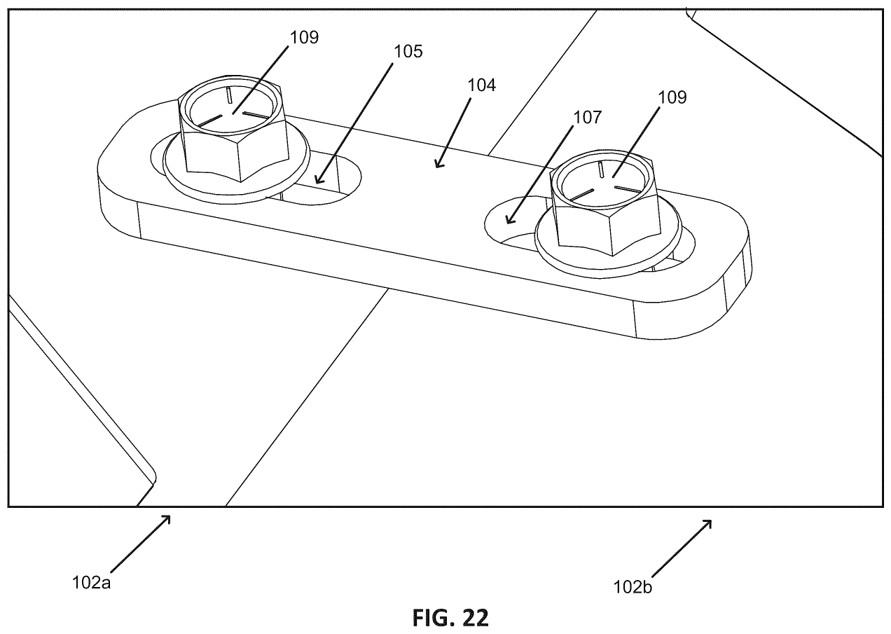

FIG. 22 is a perspective view of an example connector 104 of the debris removal system 100 of FIG. 1. In some examples, the connector 104 is used to connect the first debris removal assembly 102a to a second debris removal assembly 102b. In some examples, the connector 104 comprises an elongate body and a first connector opening 105 and a second connector opening 107. In some examples, the first connector opening 105 is located on a first end of the connector 104 and the second connector opening 107 is located on a second end of the connector 104 opposite the first end of the connector 104. In some examples, each of the first connector opening 105 and the second connector opening 107 are oval shaped openings. In some examples, a bolt 109 extends through each of the first connector opening 105 and the second connector opening 107.

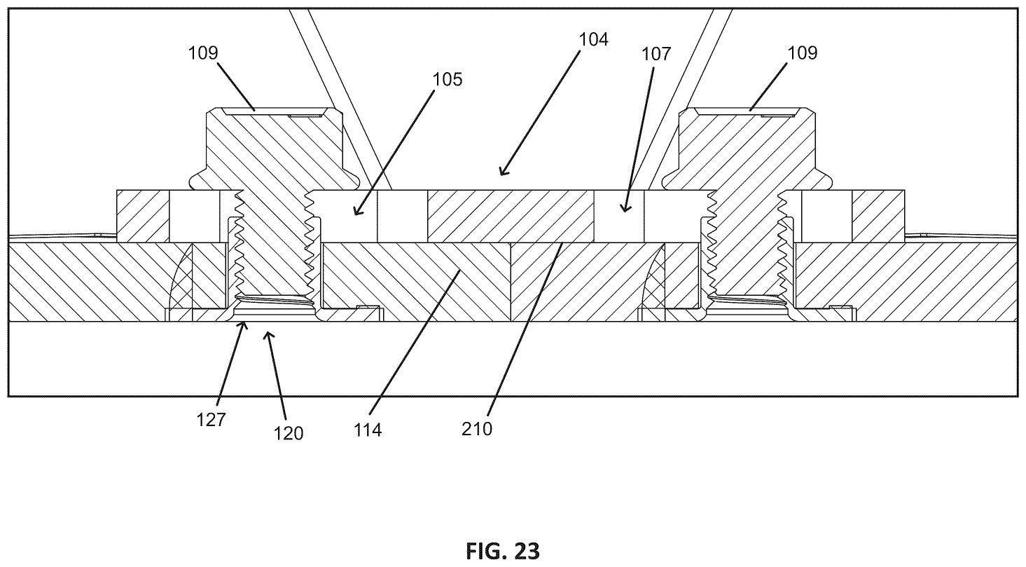

FIG. 23 is a cross-sectional view of the example connector 104 of the debris removal system 100 of FIG. 1. In the example of FIG. 23, the connectors 104 are arranged on the top side 210 of the mat 114. In some examples, the first connector opening 105 is arranged over a first connection opening 127 on a first debris removal assembly 102a and the second connector opening 107 is arranged over a second connection opening 127 on a second debris removal assembly 102b. In some examples, nuts 120 are arranged within the connection openings 127 in substantially the same manner in which the nuts 120 are arranged within the attachment opening 126, as described with reference to FIG. 20. In some examples, the neck 180 of each nut 120 extends through one of the first connector opening 105 or the second connector opening 107. In some examples, the threaded portion of each of the bolts 109 extends into the neck of each of the nuts 120. In some examples, the bolts 109 are threadedly engaged with the nuts 120 so as to secure the connector 104 into place on the top side 210 of the mats 114a, 114b.

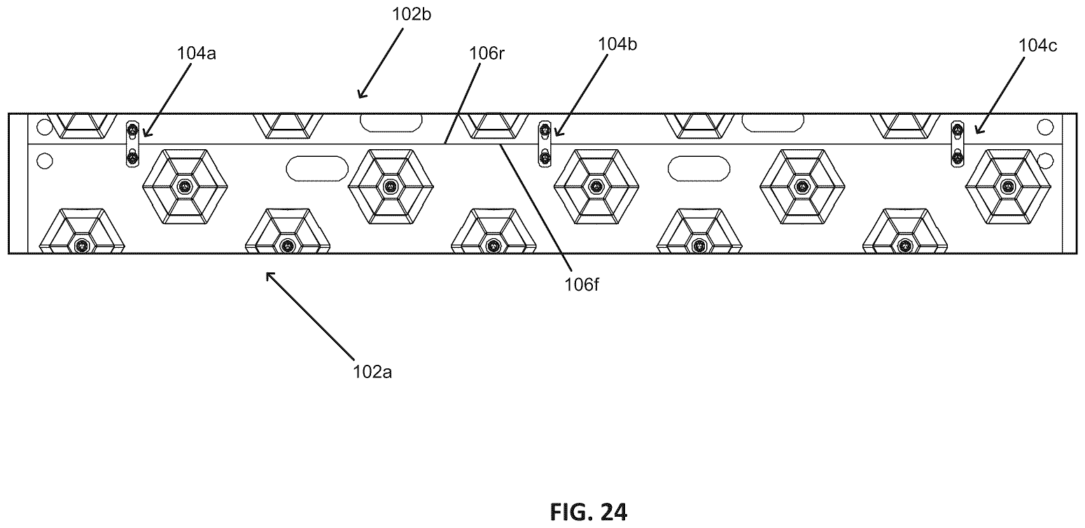

FIG. 24 is a top view of the connectors 104 used to connect the first debris removal assembly 102a to the second debris removal assembly 102b in the debris removal system 100. In some examples, the debris removal system 100 includes three connectors 104a, 104b, 104c for connecting the first debris removal assembly 102a to the second debris removal assembly 102b. In some examples the connectors 104a, 104b, 104c are equally spaced apart from each other when secured in place on the debris removal system. In some examples, greater or fewer connectors 104 may be used to connect the first debris removal assembly 102a to the second debris removal assembly 102b. In some examples, the connectors 104a, 104b, 104c each extend over the first length edge 106f of the first debris removal assembly 102a and the second length edge 106r of the second debris removal assembly 102b when used to connect the debris removal assemblies 102a, 102b along the first length edge 106f and the second length edge 106r.

In some examples, the debris removal system 100 further comprises a curb protection panel 300.

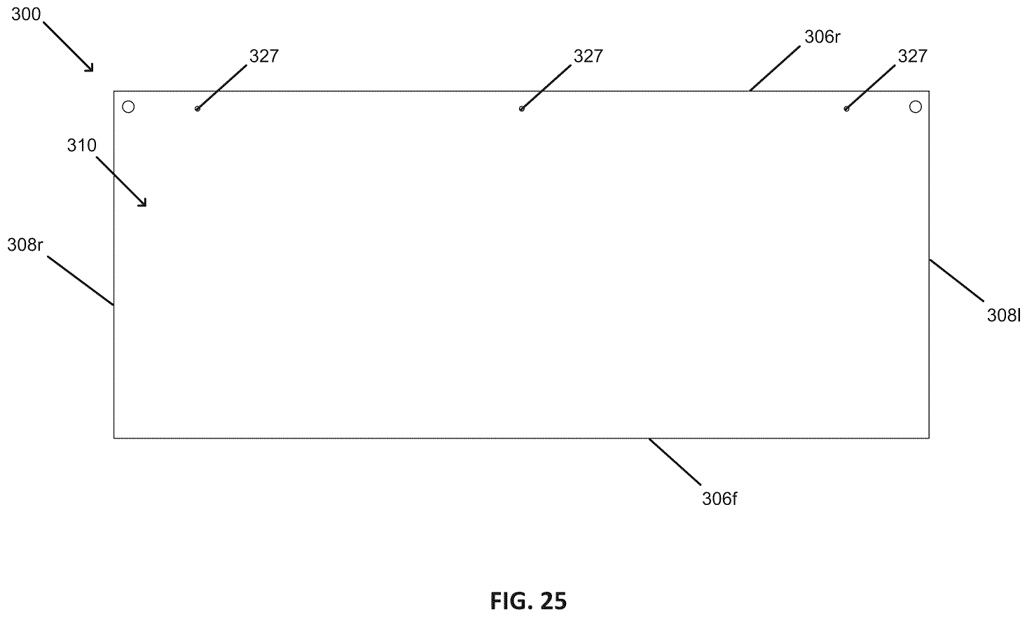

FIG. 25 is a side perspective view of an example curb protection panel 300. In some examples, heavy construction equipment, when driven over curbs adjacent a construction site, may cause damage and degradation to the curb. Thus, in some examples, it is desirable to protect the curbs adjacent to a construction site from such damage. In some examples, the curb protection panel 300 can be used within the debris removal system 100 to protect a curb over which the debris removal system 100 extends.

In some examples, the curb protection panel 300 includes a top surface 310, a bottom surface 312, a first width edge 3081, a second width edge 308r, first length edge 306f, and a second length edge 306r. In some examples, the curb protection panel 300 also includes one or more connection openings 327 arranged along the second length edge 306r. In some examples, the one or more connection openings 327 are spaced equally apart from one another in substantially the same manner as the connection openings 127. In some examples, the second length edge 306r and first length edge 306f are each longer than the first width edge 3081 and the second width edge 308r. In some examples, the second length edge 306r and the first length edge 306f are approximately the same length as the first length edge 106f and the second length edge 106r of the debris removal assembly 102.

FIG. 25 is a perspective view of the curb protection panel 300 used in combination with the debris removal assembly 102. In some examples, the second length edge 306r is configured to attach to one of the first length edge 106f or the second length edge 106r of a debris removal assembly 102. In some examples, the curb protection panel 300 is connected to the debris removal assembly 102 using fasteners 308. In some examples, the fasteners 308 include bolts that extend through each of the connection openings 327 in the curb protection panel and the connection openings 127 in the debris removal assembly 102. In some examples, the bolts are configured to threadedly engage with nuts, such as, for example, the nuts 120 described with reference to FIG. 23.

In some examples, the curb protection panel 300 comprises a material that is durable enough to withstand forces exerted by heavy construction equipment while still being flexible enough to conform to the surface of a curb. In some examples, the curb protection panel 300 comprises rubber, such as, for example, masticated rubber. In some examples, the rubber is a two-ply or three-ply rubber.

In some examples, the debris removal system 100 further comprises a cover strip 400. In some examples, the cover strip 400 is approximately the same length as the length of the second length edge 306r of the protection panel 300. In some examples, the cover strip 400 comprises one or more connection openings 427 arranged thereon. In some examples, the arrangement of the connection openings 427 corresponds to the arrangement of the connection openings 327 of the curb protection panel.

In some examples, the cover strip 400 is arranged over the curb protection panel 300 over the second length edge 306r when the cover strip 400 is connected to the debris removal assembly 102. In some examples, the cover strip 400 covers a connection between the curb protection panel 300 and the debris removal assembly 102. In some examples, the cover strip 400 comprises an HDPE material.

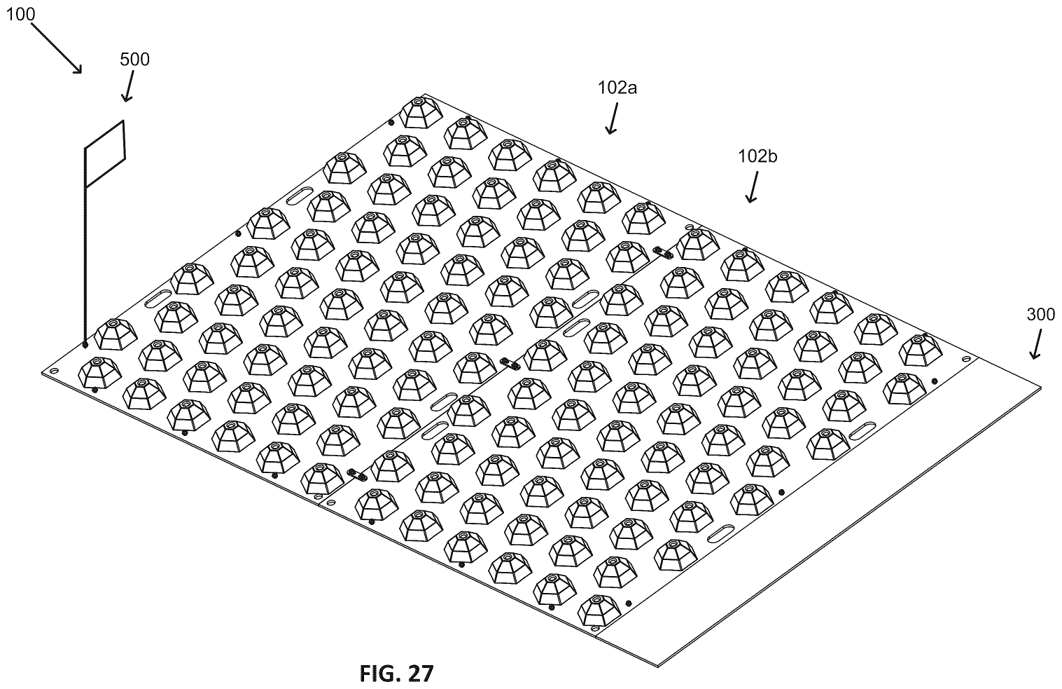

FIG. 27 is another perspective view of the example debris removal system 100. As shown in the example of FIG. 27, the debris removal system 100 includes the first debris removal assembly 102a, the second debris removal assembly 102b, and the curb protection panel 300. In some examples, the debris removal system 100 further comprises one or more attachments 500. In some examples, such as the example of FIG. 27, the one or more attachments 500 comprise a flag. In other examples, the one or more attachments 500 may comprise, for example, a sign, a plow rod, a driveway marker, an address stake, or a reflective driveway stake. In some examples, the one or more attachments 500 may comprise a lower threaded portion which can threadedly engage with one or more of the nuts 120 arranged within one or more of the connection openings 127 or the attachment openings 126.

In some examples, the debris removal system 100 is deployed by transporting one or more mats 114 and one or more knobs 116 to a construction site. In some examples, if the curb protection panel 300, cover strip 400, and/or attachments 500 are desired to be used, attachments 500, each of the curb protection panel 300, cover strip 400, and/or attachments 500 are also transported to the construction site.

After the mats 114 are transported to the construction site, the mats 114 are arranged within an egress path to the construction site. In some examples, the mats 114 are connected to each other along the first length edge 106f and the second length edge 106r using the connectors 204. In some examples, knobs 116 are attached to the top side 210 of the mats 114 to form debris removal assemblies 102. In some examples, knobless regions 103 are maintained over one or more of the debris removal assemblies 102. In some examples, a curb protection panel 300 is connected to one or more of the first length edge 106f or the second length edge 106r of the debris removal assemblies 102 and placed over a curb adjacent to the construction site. In some examples, one or more of the debris removal assemblies 102 are staked into the ground through the corner openings 129.

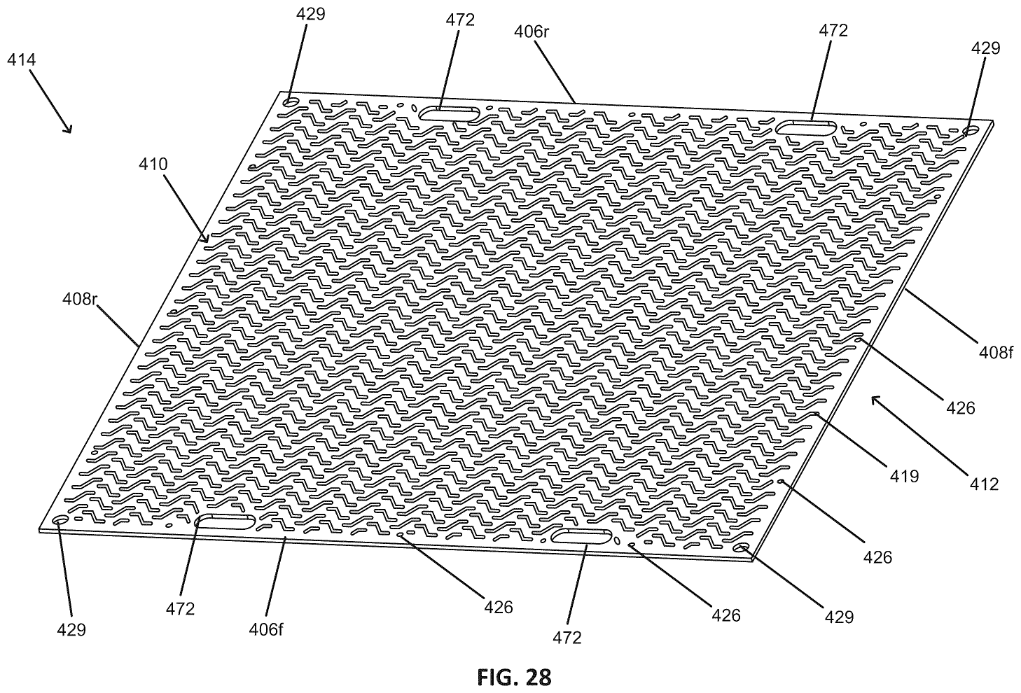

FIG. 28 is a perspective view of an example walkway mat 414. In some examples, the walkway mat 414 is substantially similar to the mat 114. In some examples, the walkway mat 414 includes a first length edge 406f located on a front side of the walkway mat 414, a second length edge 406r located on a rear side of the walkway mat 414, a first width edge 4081 located on a left side of the walkway mat 414, and a second width edge 408r located on a right side of the walkway mat 414. In some examples, the walkway mat 414 further includes a top side 410 and a bottom side 412. In some examples, the first length edge 406f, second length edge 406r, first width edge 4081 and second width edge 408r are all the same length. In some examples, the first length edge 406f, second length edge 406r, first width edge 4081 and second width edge 408r are each approximately 5 feet long.

In some examples, the walkway mat 414 further includes one or more handle openings 472, one or more connection openings 427, and one or more corner openings 429. In some examples, the handle openings 472, connection openings 427, and the corner openings 429 are configured and arranged in a substantially similar manner to the handle openings 172, connection openings 127, and corner openings 129. In some examples, the walkway mat 414 includes one or more attachment openings, configured and arranged in a substantially similar manner to the attachment openings 126. In other examples, the walkway mat 414 does not include any attachment openings.

In some examples, the top side 410 of the walkway mat 414 includes a textured surface. In some examples, the textured surface comprises one or more traction features 419. In some examples, the traction features 419 one or more raised lines extending along a portion of the top side 410. In some examples, the traction features engage with a shoe of a user to provide traction to the user as they walk along the surface of the walkway may 414.

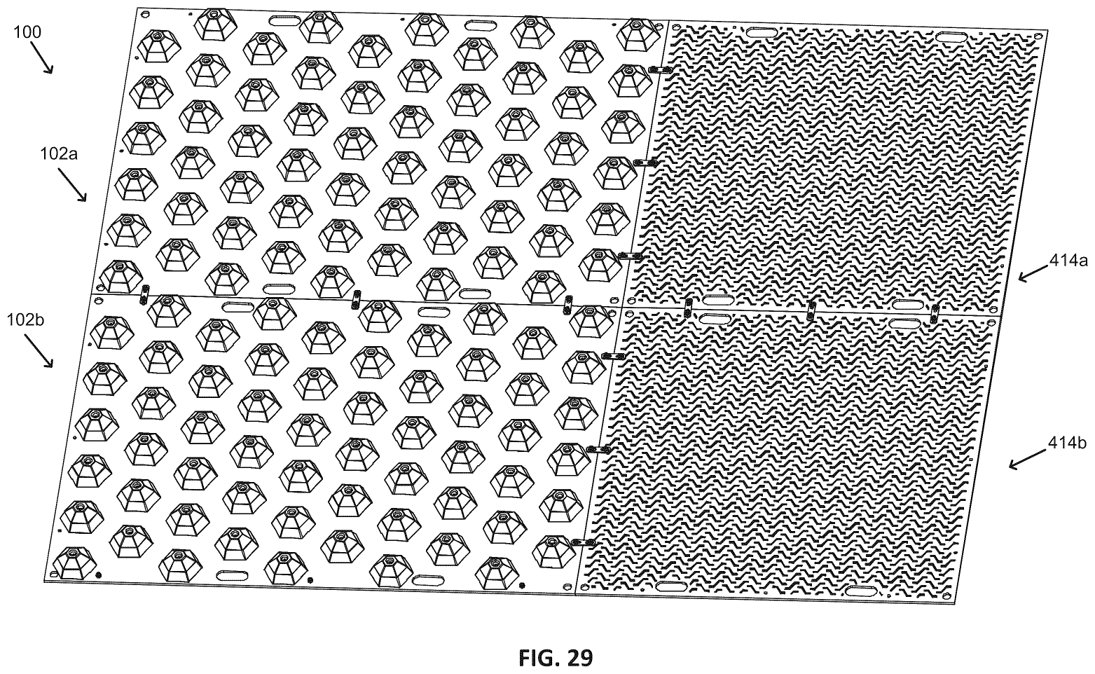

FIG. 29 is a perspective view of another example debris removal system 100. As shown in the example of FIG. 29, the debris removal system 100 includes the first debris removal assembly 102a, the second debris removal assembly 102b, a first walkway mat 414a, and a second walkway mat 414b

In some examples, the first width edge 4081 or the second width edge 408r of the first walkway mat 414a or the second walkway mat 414b is configured to attach to one of the first width edge 1081 or the second width edge 108r of a debris removal assembly 102. In some examples, the walkway mats 414 are connected to the debris removal assemblies 102 using fasteners 308. In some examples, the fasteners 308 include bolts that extend through each of the connection openings 427 in the walkway mats 414 and the connection openings 127 in the debris removal assembly 102. In some examples, the bolts are configured to threadedly engage with nuts, such as, for example, the nuts 120 described with reference to FIG. 23.

In some examples, the first walkway mat 414a and the second walkway mat 414b are configured to attach to each other along the first length edge 406f and the second length edge 406r. In some examples, the first walkway mat 414a is configured to attach to the second walkway mat 414b using fasteners, as described above with reference to the connection between the walkway mat 414 and the debris removal assembly 102. In some examples, the debris removal system 100 comprises more than two walkway mats 414 connected to each other and adjacent debris removal assemblies 102.

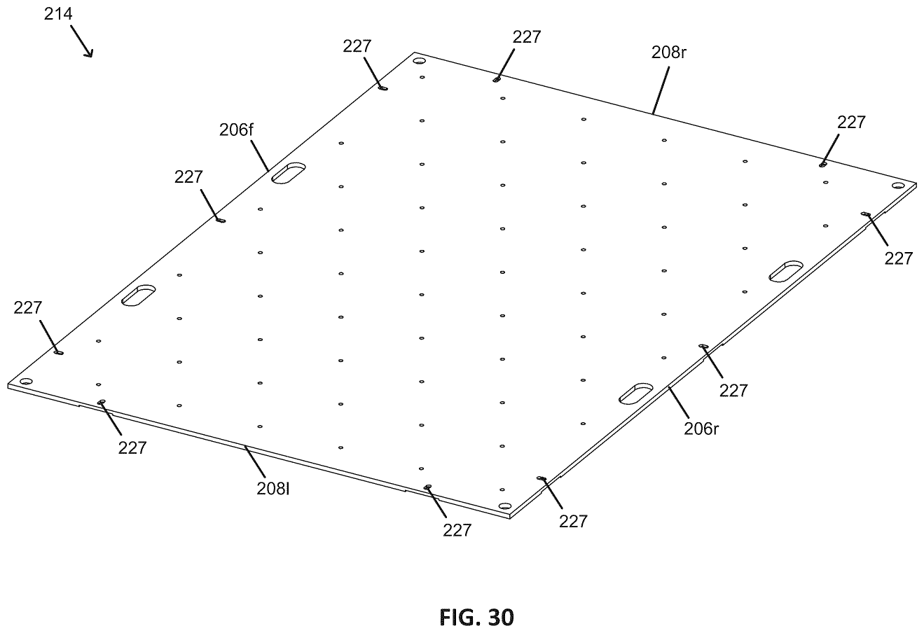

FIG. 30 is a top perspective view of another example mat 214. In some examples, the mat 114 is similar in many aspects to the mat 114 of the debris removal system 102. In some examples, the mat 214 differs from the mat 114 in the number and/or configuration of the mat attachment openings 227 arranged therethrough. In some examples, the mat 214 comprises a plurality of mat attachment openings 227 arranged adjacent to each of the first length edge 206f and the second length edge 206r and a plurality of mat attachment openings 227 arranged adjacent the first width edge 2081 and the second width edge 206r. In some examples, the mat 214 comprises two mat attachment openings 227 arranged adjacent each of the first width edge 2081 and the second width edge 208r. In some examples, the mat 214 comprises three mat attachment openings 227 arranged adjacent each of the first length edge 206f and the second length edge 206r.

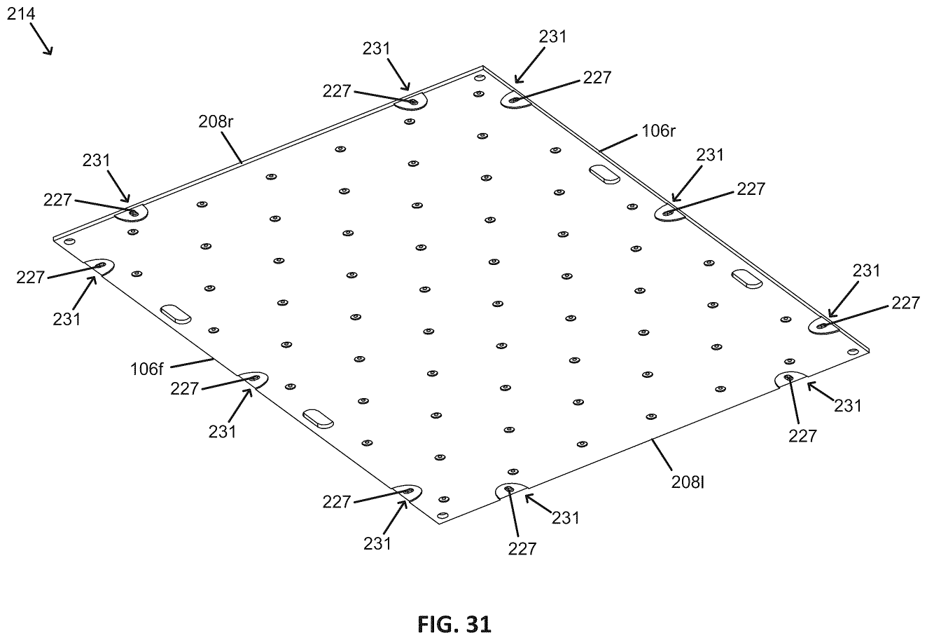

FIG. 31 is a bottom perspective view of the example mat 214. In some examples, as shown in the example of FIG. 31, the mat 214 comprises a plurality of cutouts 231 arranged adjacent each of the mat attachment openings 227. In some examples, the cutouts 231 comprise semicircular recesses in the bottom surface 212 of the mat 214 surrounding the mat attachment openings 227.

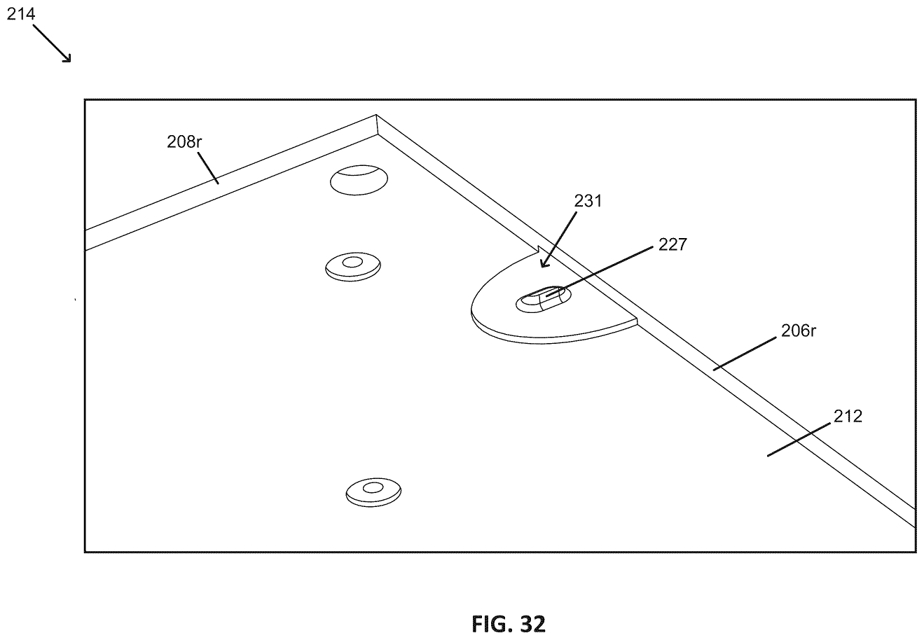

FIG. 32 is a detail bottom perspective view of the mat 214. As shown in FIG. 32, the cutouts are formed in the bottom surface 212 of the mat 214. Each one of the cutouts also extends through one of the first length edge 206f, second length edge 206r, first width edge 2081, and second width edge 208r. In some examples, each of the cutouts 231 comprises a semicircular recess in the bottom surface 212 of the mat 214.

In some examples, the mat attachment openings 227 comprise an elliptical opening. In some examples, a major axis of the elliptical opening extends generally perpendicularly from the edge at which the mat attachment opening 227 is arranged proximate to.

In some examples, the elliptical shape of the mat attachment openings 227 cases the process of attaching a second mat 214 to the mat 214 using the mat attachment opening 227. For example, the elliptical shape of the mat attachment openings 227 provides flexibility to accommodate manufacturing defects in the shape of the mat 214 when attaching the second mat 214 to the mat 214 or provides flexibility and play between the mat 214 and the second mat 214 when the mat 214 and the second mat 214 are connected together and arranged on an uneven surface. In some examples, the cutouts 213 provide a recess that allows for connection hardware used to connect the mat 214 to a second mat 214 to not extend below the bottom surface 212 of the mat 214, thereby minimizing damage to a surface underneath the mat 214 when the mat 214 is in use.

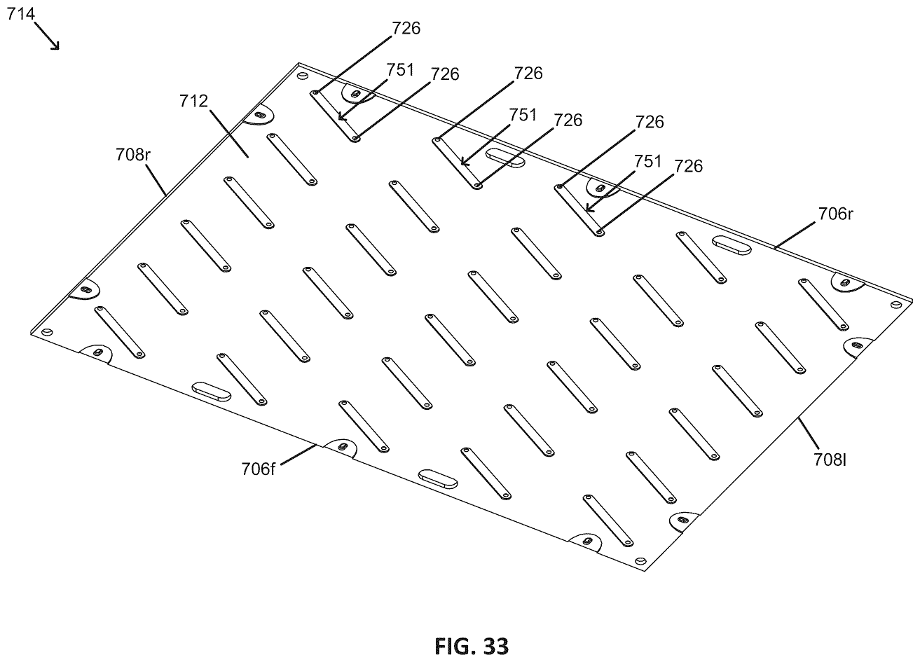

FIG. 33 is a bottom perspective view of another example mat 714. The mat 714 is similar in many aspects to the mat 214. In some examples, the mat 714 differs from the mat 214 in that the mat 714 comprises a plurality of attachment cutouts 751 formed in the bottom surface 712 of the mat 714. In some examples, the attachment cutouts 751 are formed as a single channel that extends between two adjacent attachment openings 726. In some examples, the attachment cutouts 751 entirely surround each of the two attachment openings 726 between which the attachment cutouts 751 extend. In some examples, the attachment cutouts 751 extend diagonally along the bottom surface 712 of the mat 714. In some examples, the attachment cutouts extend from a rear, right location to a front left location.

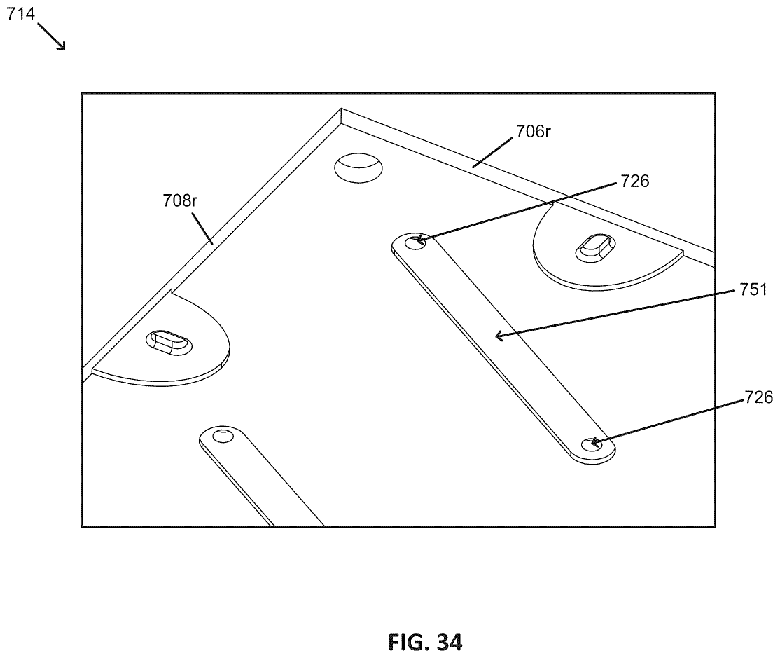

FIG. 34 is a detail bottom perspective view of the mat 714 depicting an attachment cutout 751 extending between two attachment openings 726.

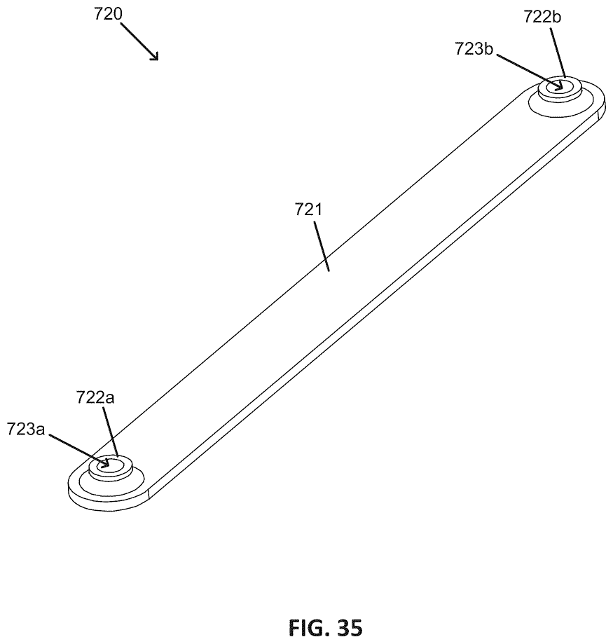

FIG. 35 is a perspective view of an attachment backing 720. In some examples, the attachment backing 720 is utilized to secure a knob 116 to the mat 714 in a similar manner to how the knob 116 is secured to the mat 114. In some examples, the attachment backing 720 replaces the nut 120 of the debris removal assembly 102. In some examples, the attachment backing 720 comprises an elongate portion 721, a first extrusion 722a, a second extrusion 722b, a first opening 723a, and a second opening 723b. In some examples, the elongate portion 721 extends between the first extrusion 722a and the second extrusion 722b. The first extrusion 722a and the second extrusion 722b extend up from the elongate portion. In some examples, each of the first extrusion 722a and the second extrusion 722b comprises a fileted corner between the first extrusion 722a and the second extrusion 722b and the elongate portion 721. In some examples, the first opening 723a is formed through the first extrusion 722a, and the second opening 723b is formed through the second extrusion 722b. In some examples, each of the first opening 723a and the second opening 723b comprise a threaded inner surface. In some examples, when that attachment backing 720 is used with the mat 714 to secure knobs 116 thereto, the elongate portion 721 is received within the attachment cutout 751 and the first extrusion 722a is received within a first attachment opening 726, while the second extrusion 722b is received within a second attachment opening 726 between which the attachment cutout 751 extends. In some examples, bolts extend into and threadedly engage with one of each of the first opening 723a and the second opening 723b in a similar manner to which is depicted and described with reference to FIG. 20.

In some examples, the configuration of the attachment backing 720 and the attachment cutouts 751 serves to increase the durability of the debris removal assembly 702. Specifically, by linking two of the knob 116 connections to the mat 714 and increasing the surface area of the attachment backing 720, the knob 116 can be prevented from being pulled out of the mat 714 as the knob 116 is driven over by a vehicle by the connection between another knob 116 and the mat 714.

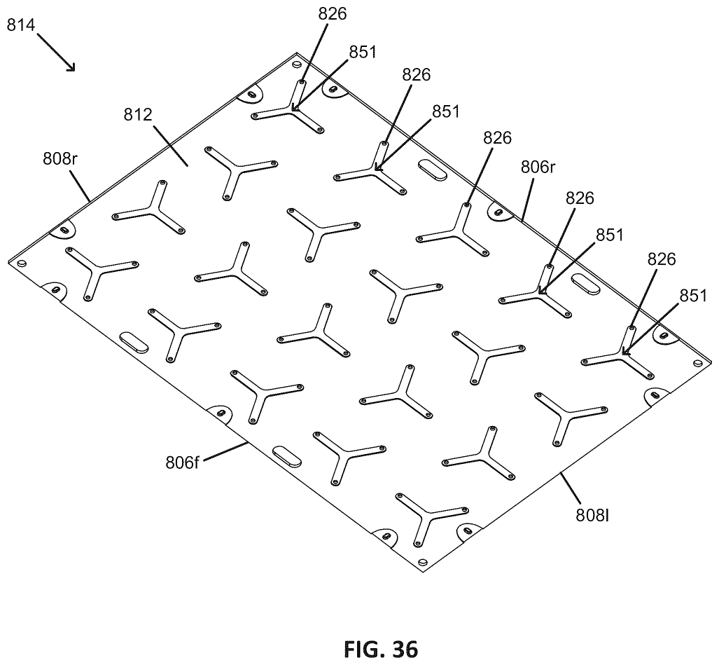

FIG. 36 is a bottom perspective view of another example mat 814. The mat 814 is similar in many aspects to the mat 714. In some examples, however, the attachment cutout 851 of the mat 814 extends between three adjacent attachment openings 826. In some examples, the attachment cutouts 851 comprise three channels, each one of which extends from different attachment opening 826, and each one of which intersect at a single point that is centered between the three different attachment openings 826.

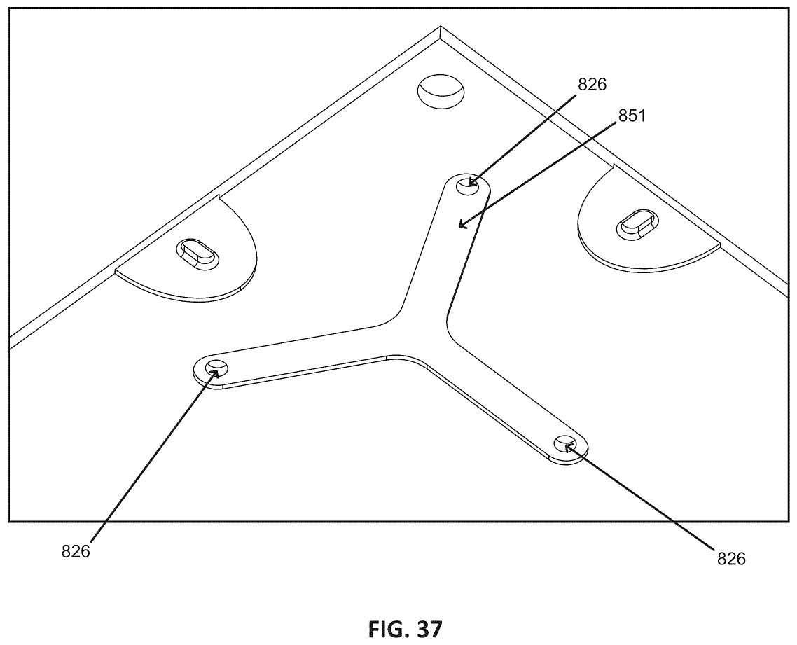

FIG. 37 is a detail bottom perspective view of the mat 814 depicting an attachment cutout 851 extending between three attachment openings 826.

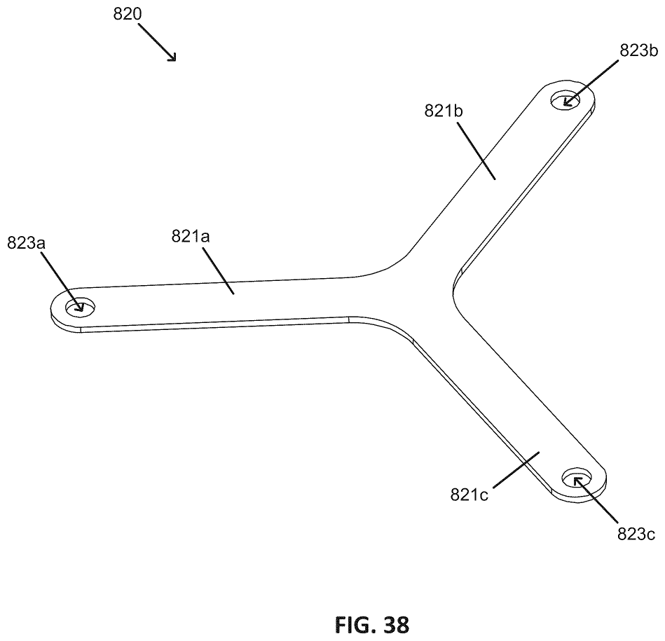

FIG. 38 is a perspective view of an example attachment backing 820. In some examples, the attachment backing 820 is utilized to secure a knob 116 to the mat 814 in a similar manner to how the knobs 116 are secured to the mat 714. In some examples, the attachment backing 820 replaces the attachment backing 720. In some examples, the attachment backing 820 comprises a first elongate portion 821a, a second elongate portion 821b, and a third elongate portion 821c. In some examples, each of the first elongate portion 821a, second elongate portion 821b, and third elongate portion 821c intersect at a single intersection point. In some examples a first opening 823a is formed through the first elongate portion 821. A second opening 823b is formed through the second elongate portion 821b. And a third opening 823c is formed through the third elongate portion 821c. In some examples, the first elongate portion 821a extends between the first opening 823a and the intersection point, the second elongate portion 821b extends between the second opening 823b and the intersection point, and the third elongate portion 821c extends between the third opening 823c and the intersection point. While not shown, in some examples, each of the first elongate portion 821a, second elongate portion 821b, and third elongate portion 821c comprise an extrusion, similar in many aspects to the extrusion 722 of the attachment backing 720.

In some examples, when that attachment backing 820 is used with the mat 814 to secure knobs 116 thereto, each one of the elongate portions 821a, 821b, 821c are received within one of the channels of the attachment cutout 851. In some examples, bolts extend into and threadedly engage with one of each of the first opening 823a, the second opening 823b, and the third opening 823c in a similar manner to which is depicted and described with reference to FIG. 20.

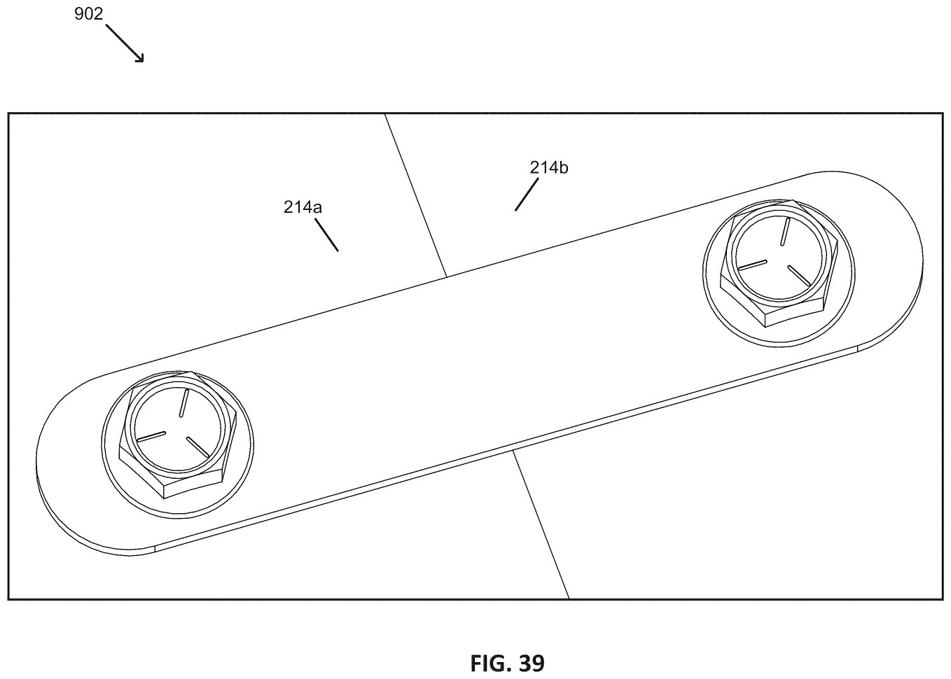

FIG. 39 is a perspective view of an example connector assembly 902. In some examples, the connector assembly 902 can be utilized to connect adjacent mats 214a, 214b, adjacent mats 714a, 714b, or adjacent mats 814a, 814b. As shown in the example of FIG. 39, the connector assembly 902 is used to connect mats 214a, 214b.

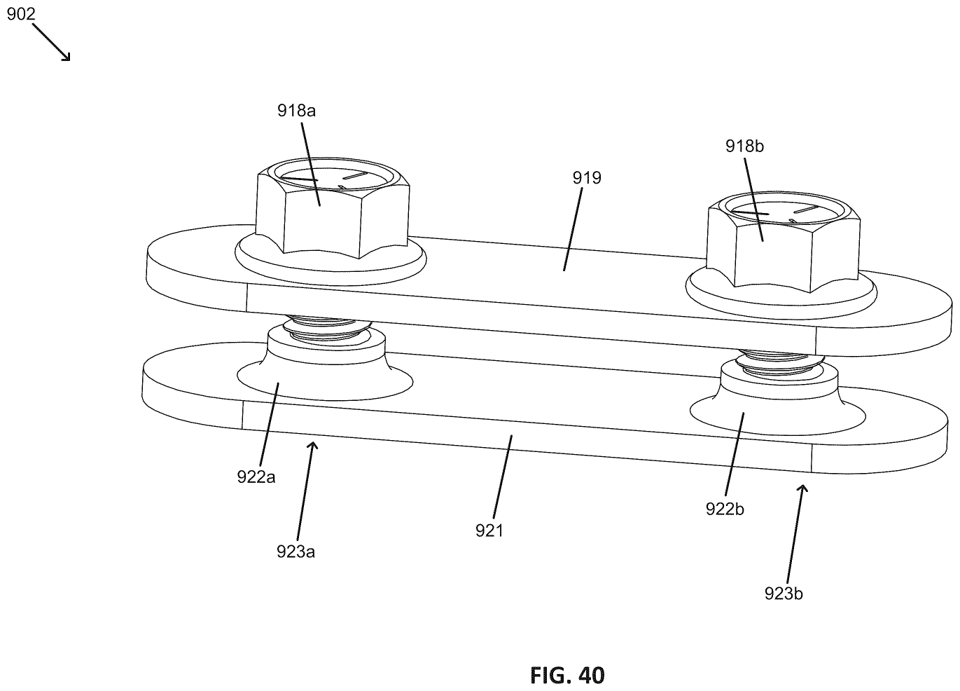

FIG. 40 is another perspective view of the connector assembly 902 with the mats 814a, 814b removed. In the example of FIG. 40, the connector assembly 902 comprises a first connector plate 919, a second connector plate 921, and bolts 918a, 918b. In some examples, the first connector plate 919 comprises an elongate strip with an opening formed therethrough at each end. The second connector plate 921 is similar in many aspects to the attachment backing 720. The bolts 918a, 918b are similar in many aspects to bolts 118. In some examples, when assembled, the first connector plate 919 is arranged over the second connector plate 921 with bolts 918a, 918b extending through each of the first connector plate 919 and the second connector plate 921 at each end of the connector assembly 902. Specifically, bolt 918a extends through the opening at the first end of the first connector plate 919 into the first opening 923a in the first extrusion 922a of the second connector plate 921. Bolt 918b extends through the opening at the second end of the first connector plate 919 into the second opening 923b in the second extrusion 922b of the second connector plate 921.

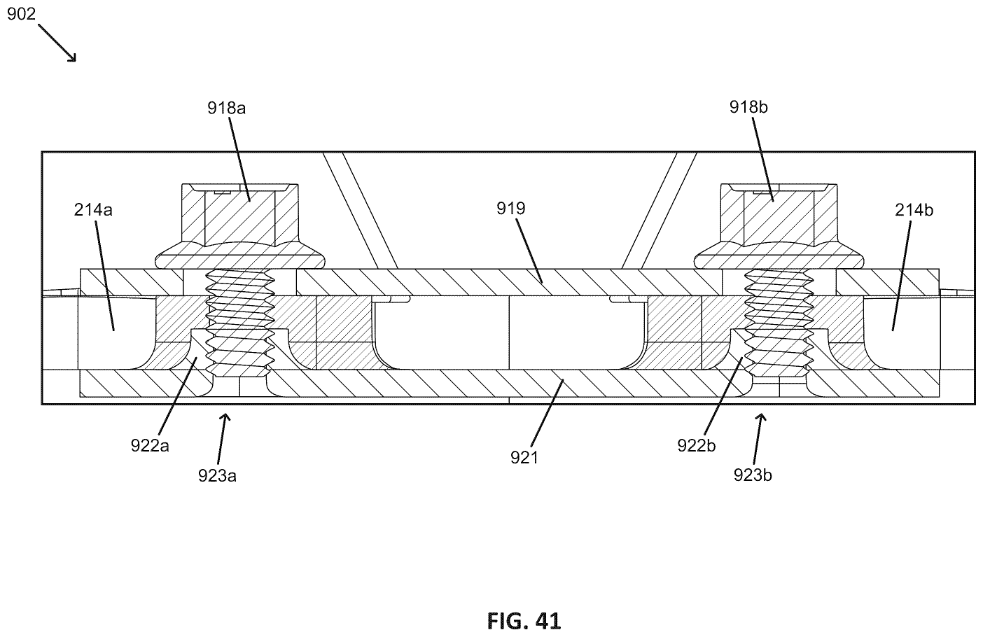

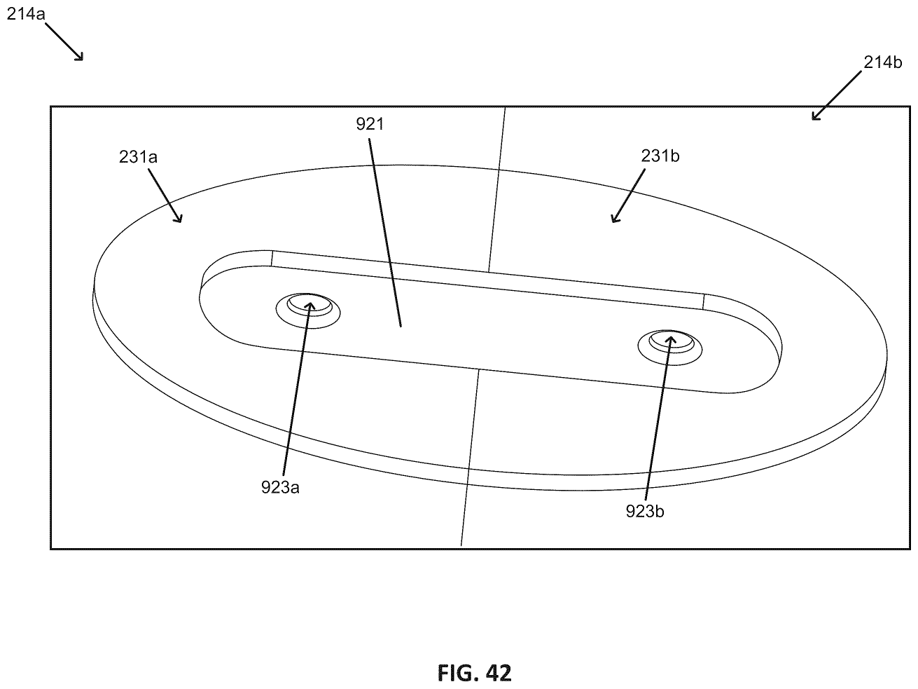

FIG. 41 is a cross-sectional view of the connector assembly 902 used to connect the first mat 214a to the second mat 214b. FIG. 42 is a bottom perspective view of the connector assembly 902 used to connect the first mat 214a to the second mat 214b. In some examples, the second connector plate 921 is received within the cutout 231a of the first mat 214a and the cutout 231b of the second mat 214b. In some examples, the first extrusion 922a of the second connector plate 921 is received into the mat attachment opening 227 of the first mat 214a, and the second extrusion 922b of the second connector plate 921 is received into the mat attachment opening 227 of the second mat 214b. In this manner, the connector assembly 902 is utilized to connect the first mat 214a to the second mat 214b. In some examples, utilizing the second connector plate 921 provides for enhanced strength between the connection between the first mat 214a and the second mat 214b.

FIG. 42 is a top view of an example curb protection panel 1000. In some examples, the curb protection panel 1000 is similar in many aspects to the curb protection panel 300. In some examples, the curb protection panel 1000 differs from the curb protection panel 300 in the number of connection openings 1027 arranged thereon. In some examples, the curb protection panel 1000 comprises five connection openings 1027 spaced apart and arranged thereon.

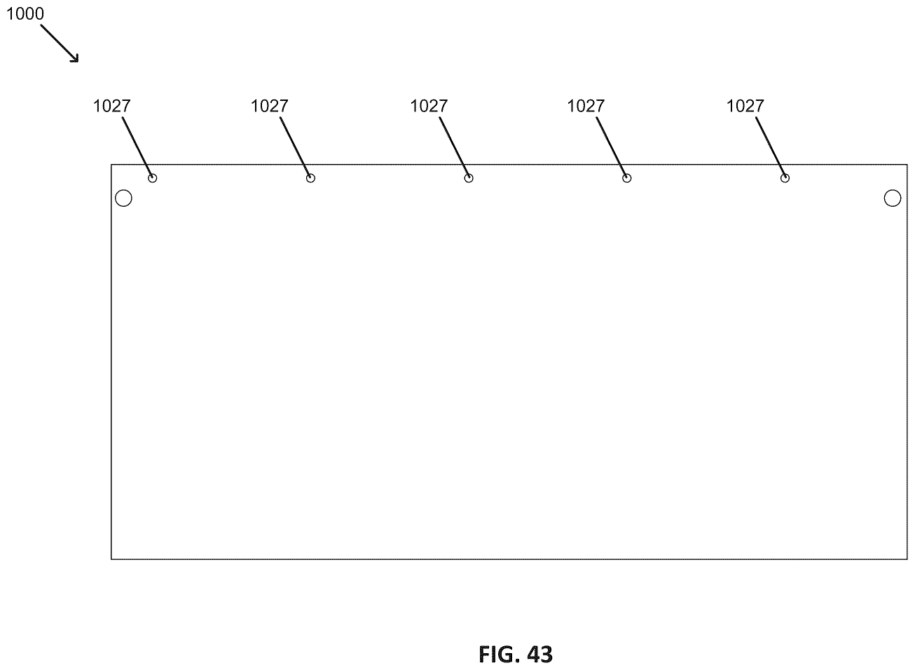

FIG. 43 is a perspective view of the curb protection panel 1000 attached to the mat 214. In some examples, a cover strip 1100 is used to connect the curb protection panel 1000 to the mat 214. In some examples, the cover strip 1100 comprises openings therethrough that align with the connection openings 1027 of the curb protection panel 1000. In some examples, when attached to the mat 214, a portion of the curb protection panel 1000 is arranged between the cover strip 1100 and the mat 214.

This disclosure should be understood to include (as illustrative and not limiting) the subject matter set forth in the following numbered clauses:

Clause 1. A debris removal assembly for removing debris from a vehicle, the debris removal assembly comprising:
a mat; and
one or more knobs attached to a top side of the mat, the one or more knobs being removable from the mat.

Clause 2. The debris removal assembly of any of the preceding clauses, wherein the mat comprises one or more attachment openings formed therein.

Clause 3. The debris removal assembly of any of the preceding clauses, wherein the one or more knobs each include a central hole formed therein.

Clause 4. The debris removal assembly of any of the preceding clauses, further comprising a fastener extending through the central hole of one of the one or more knobs and one of the one or more attachment openings.

Clause 5. The debris removal assembly of any of the preceding clauses, wherein the one or more knobs each comprises a top face, six upper angled faces, and six lower angled faces.

Clause 6. The debris removal assembly of any of the preceding clauses, wherein the central hole extends through the top face of the one or more knobs.

Clause 7. The debris removal assembly of any of the preceding clauses, wherein each of the one or more knobs comprises one or more ribs.

Clause 8. The debris removal assembly of any of the preceding clauses, wherein the one or more knobs each comprises a top face.

Clause 9. The debris removal assembly of any of the preceding clauses, wherein the top face is substantially parallel with the top side of the mat.

Clause 10. The debris removal assembly of any of the preceding clauses, wherein the debris removal assembly comprises a first width edge and a first length edge that is longer than the first width edge, wherein the vehicle, when driving over the debris removal assembly, drives in a direction of travel substantially parallel to the first width edge.

Clause 11. A knob for deforming vehicle tire in a debris removal assembly, the knob comprising:
a top face;
a bottom face; and
a central hole extending from the top face through the bottom face.

Clause 12. The knob of any of the preceding clauses, wherein the top face is formed in a shape of a polygon.

Clause 13. The knob of any of the preceding clauses, wherein the knob further comprises one or more angled side faces, the number of angled side faces being equal to the number of sides of the polygon.

Clause 14. The knob of any of the preceding clauses, wherein the knob further comprises one or more second angled side faces that are separate from the one or more angled side faces, the number of the one or more second angled side faces being equal to the number of sides of the polygon.

Clause 15. The knob of any of the preceding clauses, further comprising one or more angled face edges arranged between the one or more angled side faces and the one or more second angled side faces.

Clause 16. The knob of any of the preceding clauses, wherein a height between the bottom face and the top face of the knob is about 2.75 inches.

Clause 17. A debris removal system for removing debris from a vehicle, the debris removal system comprising:
a first debris removal assembly;
a second debris removal assembly; and
a connector for connecting the first debris removal assembly to the second debris removal assembly.

Clause 18. The debris removal system of any of the preceding clauses, wherein each of the first debris removal assembly and the second debris removal assembly comprise a first length edge and a first width edge, the first length edge being longer than the first width edge.

Clause 19. The debris removal system of any of the preceding clauses, wherein the first length edge of the first debris removal assembly is arranged adjacent to the first length edge of the second debris removal assembly when the first debris removal assembly is connected to the second debris removal assembly.

Clause 20. The debris removal system of any of the preceding clauses, wherein the connector comprises a main body with a first connector opening and a second connector opening.

Clause 21. The debris removal system of any of the preceding clauses, wherein the connector extends between the first debris removal assembly and the second debris removal assembly.

Clause 22. The debris removal system of any of the preceding clauses, further comprising:
a first bolt extending through the first connector opening of the connector and a first connection opening of the first debris removal assembly; and
a second bolt extending through the second connector opening of the connector and a second connection opening of the second debris removal assembly.

Clause 23. The debris removal system of any of the preceding clauses, wherein each of the first debris removal assembly and the second debris removal assembly comprise one or more knobs for deforming a tire of the vehicle.

Clause 24. The debris removal system of any of the preceding clauses, wherein at least one of the one or more knobs is removable from at least one of the first debris removal assembly and the second debris removal assembly.

Clause 25. The debris removal system of any of the preceding clauses, further comprising a curb protection panel.

Clause 26. The debris removal system of any of the preceding clauses, wherein the curb protection panel is able to conform to a shape of a curb over which it is arranged.

Clause 27. The debris removal system of any of the preceding clauses, wherein the curb protection panel is connected to the first length edge of the first debris removal assembly.

Clause 28. A method of assembling a debris removal system for a vehicle, the method comprising:
arranging a first mat within an egress pathway of a construction site; and
attaching one or more knobs for deforming a tire of the vehicle to a top side of the first mat.

Clause 29. The method of any of the preceding clauses, wherein attaching one or more knobs for deforming the tire of the vehicle to a top side of the first mat includes:
inserting a fastener through a central hole in one of the one or more knobs;
extending the fastener through an attachment hole in the first mat; and
threading the fastener into a nut arranged at a bottom side of the first mat.

Clause 30. The method of any of the preceding clauses, further comprising arranging a second mat within the egress pathway.

Clause 31. The method of any of the preceding clauses, further comprising connecting the second mat to the first mat.

Clause 32. The method of any of the preceding clauses, wherein connecting the second mat to the first mat includes:
inserting a second fastener through a first connection hole in a connector;
extending the second fastener through a second attachment hole in the first mat;
threading the second fastener into a second nut arranged at a bottom side of the first mat;
inserting a third fastener through a second connection hole in the connector;
extending the third fastener through a third attachment hole in the second mat; and
threading the third fastener into a third nut arranged at a bottom side of the second mat.

Clause 33. The method of any of the preceding clauses, further comprising attaching one or more knobs for deforming the tire of the vehicle to a top side of the second mat.

Clause 34. A method of assembling a debris removal system for a vehicle, the method comprising:
arranging a first mat within an egress pathway of a construction site; and
removing one or more knobs for deforming a tire of the vehicle from a top side of the first mat.

Clause 35. The method of any of the preceding clauses, wherein removing one or more knobs for deforming the tire of the vehicle from a top side of the first mat includes:
unthreading a fastener from a nut arranged at a bottom side of the first mat; and
removing the fastener from a central hole in one of the one or more knobs.

Clause 36. The method of any of the preceding clauses, further comprising arranging a second mat within the egress pathway.

Clause 37. The method of any of the preceding clauses, further comprising connecting the second mat to the first mat.

Clause 38. The method of any of the preceding clauses, wherein connecting the second mat to the first mat includes:
inserting a second fastener through a first connection hole in a connector;
extending the second fastener through a second attachment hole in the first mat;
threading the second fastener into a second nut arranged at a bottom side of the first mat;
inserting a third fastener through a second connection hole in the connector;
extending the third fastener through a third attachment hole in the second mat; and
threading the third fastener into a third nut arranged at a bottom side of the second mat.

Clause 39. The method of any of the preceding clauses, further comprising removing one or more knobs for deforming the tire of the vehicle from a top side of the second mat.

Clause 40. A mat for a debris removal assembly for a vehicle, the mat comprising:
a top face;
a bottom face;
an opening extending from the top face through the bottom face; and
a T-nut extending through the opening.

Clause 41. The mat of any of the preceding clauses, wherein the T-nut comprises a neck and a flange, wherein the neck is connected to the flange at a first end and extends from the opening through the top face of the mat.

Clause 42. The mat of any of the preceding clauses, comprising a first width edge and a first length edge that is longer than the first width edge.

Clause 43. The mat of any of the preceding clauses, further comprising a second opening spaced apart from the opening by a first distance and a third opening spaced apart from the opening by a second distance.

Clause 44. The mat of any of the preceding clauses, wherein the first distance is in a first direction substantially parallel to the first width edge.

Clause 45. The mat of any of the preceding clauses, wherein the second distance is in a second direction substantially parallel to the first length edge.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A debris removal assembly for removing debris from a vehicle, the debris removal assembly comprising:
a mat; and
one or more knobs attached to a top side of the mat, the one or more knobs being removable from the mat.

2. The debris removal assembly of claim 1, wherein the mat comprises one or more attachment openings formed therein.

3. The debris removal assembly of claim 2, wherein the one or more knobs each include a central hole formed therein.

4. The debris removal assembly of claim 3, further comprising a fastener extending through the central hole of one of the one or more knobs and one of the one or more attachment openings, wherein the fastener is threadedly engaged with a backing plate, the backing plate extending between a plurality of the one or more attachment openings.

5. The debris removal assembly of claim 4, wherein the one or more knobs each comprises a top face, six upper angled faces, and six lower angled faces.

6. The debris removal assembly of claim 5, wherein the central hole extends through the top face of the one or more knobs.

7. The debris removal assembly of claim 6, wherein each of the one or more knobs comprises one or more ribs.

8. The debris removal assembly of claim 4, wherein the one or more knobs each comprises a top face.

9. The debris removal assembly of claim 8, wherein the top face is substantially parallel with the top side of the mat.

10. The debris removal assembly of claim 8, wherein the debris removal assembly comprises a first width edge and a first length edge that is longer than the first width edge, wherein the vehicle, when driving over the debris removal assembly, drives in a direction of travel substantially parallel to the first width edge.

11. A knob for deforming vehicle tire in a debris removal assembly, the knob comprising:
a top face;
a bottom face; and
a central hole extending from the top face through the bottom face.

12. The knob of claim 11, wherein the top face is formed in a shape of a polygon.

13. The knob of claim 12, wherein the knob further comprises one or more angled side faces, the number of angled side faces being equal to the number of sides of the polygon.

14. The knob of claim 13, wherein the knob further comprises one or more second angled side faces that are separate from the one or more angled side faces, the number of the one or more second angled side faces being equal to the number of sides of the polygon.

15. The knob of claim 14, further comprising one or more angled face edges arranged between the one or more angled side faces and the one or more second angled side faces.

16. The knob of claim 11, wherein a height between the bottom face and the top face of the knob is about 2.75 inches.

17. A debris removal system for removing debris from a vehicle, the debris removal system comprising:
a first debris removal assembly;
a second debris removal assembly; and
a connector for connecting the first debris removal assembly to the second debris removal assembly.

18. The debris removal system of claim 17, wherein each of the first debris removal assembly and the second debris removal assembly comprise a first length edge and a first width edge, the first length edge being longer than the first width edge.

19. The debris removal system of claim 18, wherein the first length edge of the first debris removal assembly is arranged adjacent to the first length edge of the second debris removal assembly when the first debris removal assembly is connected to the second debris removal assembly.

20. The debris removal system of claim 19, wherein the connector comprises a connector assembly, and wherein the connector assembly comprises a first plate with a main body with a first connector opening and a second connector opening, and a second plate with a main body with a first connector opening and a second connector opening, wherein the second plate is received within a cutout of a first mat of the first debris removal assembly and a cutout of a second mat of the second debris removal assembly.
